(19) United States
(12) Patent Application Publication
(10) Pub. No.: US 2025/0053700 A1
(43) Pub. Date: Feb. 13, 2025

(54) DISTRIBUTED ENERGY RESOURCE SUBSYSTEM EFFECTIVE NEUTRAL GROUNDING

(71) Applicant: Quanta Technology, LLC, Raleigh, NC (US)

(72) Inventors: Rahim Jafari, Vaughan (CA); Amin Zamani, Mississauga (CA); Shadi Chuangpishit, Richmond Hill (CA); Farid Katiraei, Markham (CA)

(21) Appl. No.: 18/799,133

(22) Filed: Aug. 9, 2024

Related U.S. Application Data
(60) Provisional application No. 63/518,936, filed on Aug. 11, 2023.

(51) Int. Cl. G06F 30/20; G06F 111/06; G06F 113/04; G06F 119/02; G06F 119/06

(52) U.S. Cl. CPC G06F 30/20; G06F 2111/06; G06F 2113/04; G06F 2119/02; G06F 2119/06

(57) ABSTRACT

A method is provided for designing grounding equipment to account for interconnection of a distributed energy resource (DER) subsystem to an area electric power system (EPS). The method includes, for each of multiple possible modes of operation of the DER subsystem and/or for each of multiple possible sets of value(s) of unknown parameter(s), calculating a temporary overvoltage (TOV) level and/or a coefficient of grounding (COG) that would be associated with different possible grounding equipment designs. Here, the different possible designs comprise different possible grounding equipment types and/or different possible grounding equipment sizing configurations. The method also comprises determining, based on the calculated TOV levels and/or coefficients of grounding that would be associated with the different possible designs, a design that would meet a requirement on effectiveness of the grounding equipment across the multiple possible modes of operation and/or across the different possible sets of value(s) of the unknown parameter(s).

### RELATED APPLICATIONS

This application claims the benefit of U.S. Provisional Patent Application No. 63/518,936, filed Aug. 11, 2023, which is incorporated by reference herein in its entirety.

### TECHNICAL FIELD

The present application relates generally to a distributed energy resource (DER) subsystem and relates more particularly to effective neutral grounding of such a subsystem.

### BACKGROUND

A traditional power system centralizes power generation at the utility level and distributes bulk power to communities via an area electric power system (EPS). An area EPS in this regard refers to the electrical infrastructure that distributes electricity over a defined geographic area, typically managed by utility companies. It includes components like power plants, substations, transmission lines, and distribution networks that work together to deliver electricity from centralized generation sources to end-users. The utility grid, which is a critical part of the area EPS, serves as the backbone of this infrastructure, ensuring the coordinated flow of electricity across vast distances and diverse regions.

By contrast, a Distributed Energy Resource (DER) subsystem consists of smaller, decentralized generation units, such as solar panels, wind turbines, energy storage systems (ESSs), plug-in electric vehicles (PEVs), and other renewable sources, often located close to the point of consumption. While an area EPS focuses on the broad delivery of power across extensive networks, a DER subsystem emphasizes localized energy production and consumption, enhancing grid reliability, reducing transmission losses, and supporting renewable energy integration. The utility grid facilitates the integration of DERs by providing a platform for these smaller systems to feed excess energy back into the larger network, thus creating a more resilient and flexible overall power system.

DERs have been more formally defined by the North American Electric Reliability Corp. (NERC), which is the national entity responsible for reliability of the bulk electric system over the continental United States, Canada, and the northern portion of Baja California, Mexico. NERC defines a Distributed Energy Resource (DER) as follows: “A Distributed Energy Resource (DER) is any resource on the distribution system that produces electricity and is not otherwise included in the formal NERC definition of the Bulk Electric System.” Here, the distribution system refers to the lower-voltage (under 33-kV) lines such as those carrying power from substations to end-users, as opposed to large, high-voltage transmission lines mounted on lattice tower structures. The Bulk Electric System (BES) refers to transmission elements operated at 100-kV or higher and real power and reactive power resources connected at 100-kV or higher. It does not include facilities used in the local distribution of electric energy.

DERs may thereby include any non-bulk electric system resource-generating unit, multiple generating units at a single location, energy storage facility, or microgrid-located solely within the boundary of any distribution utility, according to NERC. DERs may also include behind-the-meter generation such as solar photovoltaic, and energy storage facilities or multiple devices at a single location on either the utility or customer's side of the meter, including electric-vehicle charging stations.

As one type of DER subsystem, a microgrid is a localized, controllable energy system—generation and load—that is capable of being “islanded” from the electricity grid within a specifically defined area. According to the U.S. Department of Energy, a microgrid is a group of interconnected loads and DERs within clearly defined electrical boundaries that act as a single controllable entity with respect to the grid. A microgrid can connect and disconnect from the grid to enable it to operate in either grid-connected or island mode. Additionally, the microgrid's operational controls need to be fully coordinated when connected to the main power grid or while islanded, requiring additional equipment, communications and control applications. A DER subsystem such as a microgrid may thereby support multiple different possible modes of operation, such as grid-connected mode, island mode, etc.

Despite the advantages of DER subsystems, challenges exist with regard to designing neutral grounding for a DER subsystem. Neutral grounding of a DER subsystem involves connecting a neutral point for the DER subsystem to ground (Earth), to provide a controlled path for fault currents and to help stabilize the system voltage during unbalanced conditions. This practice protects both the electrical equipment and personnel by reducing the risk of electrical shocks and equipment damage. Industry standards and regulations typically define requirements for how effective neutral grounding must comply with those standards and regulations. See, e.g., IEEE Std. C57.32, IEEE Std. C62.92.1, IEEE Std. C62.92.2, IEEE Std. C62.92.6, and IEEE Std. 142. For example, industry standards and regulations may dictate that neutral grounding must provide a coefficient of grounding (COG) less than a threshold (e.g., 80%) to be effective, e.g., for adequately controlling overvoltages and ensuring safety during fault conditions.

The proliferation of inverter-based resources (IBRs) within DER subsystems creates challenges for effective neutral grounding design, though. An inverter is a power electronic device designed to convert direct current (DC) power into alternating current (AC) power, i.e., effectively inverting a rectifier's operation. The integration of IBRs into DER subsystems brings about new possibilities but also introduces challenges for neutral grounding design. Unlike synchronous generation, IBRs may exhibit different behavior in response to disturbances on the electric grid and as such may have uncharacterized fault current behavior. This uncharacterized fault current behavior creates uncertainty with regard to how to design neutral grounding equipment for a DER subsystem to be effective, much less in a way that accommodates for the possibility that the DER subsystem may operate in different modes. Because of this, power engineers heretofore resort to overdimensioning grounding equipment for DER subsystems to confidently safeguard against the uncertainty attributable to IBRs and/or varied operating modes. Overdimensioning grounding equipment in this way increases confidence in protection but undesirably adds meaningful costs. Moreover, overdimensioning grounding equipment risks reducing fault current to levels that are too low for certain overcurrent protective relays to detect accurately and thereby threatens to undesirably de-sensitize overcurrent protective relays. This ultimately jeopardizes fault detection and clearance and in turn threatens system damage and personnel safety.

### SUMMARY

Some embodiments herein enable the appropriately-dimensioned design of grounding equipment that would meet a requirement on effectiveness of the grounding equipment for neutral grounding of a distributed energy resource (DER) subsystem. Notably, some embodiments enable this grounding equipment design to meet the effective neutral grounding requirement even across the multiple possible modes of operation of the DER subsystem, e.g., across both connected mode (in which the DER subsystem is connected to an area electric power system (EPS)) and an islanded mode (in which the DER subsystem is islanded from the area EPS). Alternatively or additionally, some embodiments enable the grounding equipment design to meet the effective neutral grounding requirement even across different possible values of unknown parameter(s), e.g., associated with a negative-sequence impedance of the DER subsystem and/or attributable to inverter-based resources in the DER subsystem. Some embodiments thereby advantageously enable neutral grounding design for inverter-based DER subsystems in a way that avoids over-dimensioned grounding equipment, which in turn reduces costs, improves system protection, and enhances personnel safety.

More particularly, embodiments herein include a non-transitory computer-readable medium on which is stored a computer program comprising instructions that, when executed by a processor of computing equipment, causes the computing equipment to obtain values of area EPS parameters describing an area electric power system (EPS). The instructions also cause the computing equipment to obtain values of DER subsystem parameters describing a distributed energy resource (DER) subsystem. The instructions also cause the computing equipment to, for each of multiple possible modes of operation of the DER subsystem and/or for each of multiple possible sets of one or more values for one or more unknown parameters, calculate, based on the values of the area EPS parameters and the values of the DER subsystem parameters, a temporary overvoltage (TOV) level and/or a coefficient of grounding (COG) that would be associated with different possible designs of grounding equipment for neutral grounding of the DER subsystem. In some embodiments, the different possible designs of grounding equipment comprise different possible types of grounding equipment and/or different possible sizing configurations of grounding equipment. In some embodiments, the multiple possible modes include an area EPS connected mode in which the DER subsystem is connected to the area EPS and an island mode in which the DER subsystem is islanded from the area EPS, and each of the one or more unknown parameters is associated with a negative-sequence impedance of the DER subsystem. The instructions also cause the computing equipment to determine, based on the calculated TOV levels and/or coefficients of grounding that would be associated with the different possible designs of grounding equipment, a design of grounding equipment, if any, that would meet a requirement on effectiveness of the grounding equipment for neutral grounding of the DER subsystem across the multiple possible modes of operation of the DER subsystem and/or across the multiple possible sets of one or more values for the one or more unknown parameters.

Other embodiments herein include a method of designing grounding equipment to account for interconnection of a distributed energy resource (DER) subsystem to an area electric power system (EPS). The method comprises obtaining values of area EPS parameters describing an area electric power system (EPS). The method also comprises obtaining values of DER subsystem parameters describing a distributed energy resource (DER) subsystem. The method also comprises, for each of multiple possible modes of operation of the DER subsystem and/or for each of multiple possible sets of one or more values for one or more unknown parameters, calculating, based on the values of the area EPS parameters and the values of the DER subsystem parameters, a temporary overvoltage (TOV) level and/or a coefficient of grounding (COG) that would be associated with different possible designs of grounding equipment for neutral grounding of the DER subsystem. In some embodiments, the different possible designs of grounding equipment comprise different possible types of grounding equipment and/or different possible sizing configurations of grounding equipment. In some embodiments, the multiple possible modes include an area EPS connected mode in which the DER subsystem is connected to the area EPS and an island mode in which the DER subsystem is islanded from the area EPS, and each of the one or more unknown parameters is associated with a negative-sequence impedance of the DER subsystem. The method also comprises determining, based on the calculated TOV levels and/or coefficients of grounding that would be associated with the different possible designs of grounding equipment, a design of grounding equipment, if any, that would meet a requirement on effectiveness of the grounding equipment for neutral grounding of the DER subsystem across the multiple possible modes of operation of the DER subsystem and/or across the multiple possible sets of one or more values for the one or more unknown parameters.

Other embodiments herein include a method for distributing a computer program over a network. The method comprises providing a downloadable computer program accessible via an Internet website. The method also comprises receiving a request for the downloadable computer program from a user device connected to the Internet. The method also comprises transmitting the downloadable computer program from a server to the user device in response to the request. In some embodiments, the downloadable computer program comprises executable instructions for obtaining values of area EPS parameters describing an area electric power system (EPS). In some embodiments, the downloadable computer program comprises executable instructions for obtaining values of DER subsystem parameters describing a distributed energy resource (DER) subsystem. In some embodiments, the downloadable computer program comprises executable instructions for, for each of multiple possible modes of operation of the DER subsystem and/or for each of multiple possible sets of one or more values for one or more unknown parameters, calculating, based on the values of the area EPS parameters and the values of the DER subsystem parameters, a temporary overvoltage (TOV) level and/or a coefficient of grounding (COG) that would be associated with different possible designs of grounding equipment for neutral grounding of the DER subsystem. In some embodiments, the different possible designs of grounding equipment comprise different possible types of grounding equipment and/or different possible sizing configurations of grounding equipment. In some embodiments, the multiple possible modes include an area EPS connected mode in which the DER subsystem is connected to the area EPS and an island mode in which the DER subsystem is islanded from the area EPS, and each of the one or more unknown parameters is associated with a negative-sequence impedance of the DER subsystem. In some embodiments, the downloadable computer program comprises executable instructions for determining, based on the calculated TOV levels and/or coefficients of grounding that would be associated with the different possible designs of grounding equipment, a design of grounding equipment, if any, that would meet a requirement on effectiveness of the grounding equipment for neutral grounding of the DER subsystem across the multiple possible modes of operation of the DER subsystem and/or across the multiple possible sets of one or more values for the one or more unknown parameters.

Still other embodiments herein include corresponding computing equipment.

### BRIEF DESCRIPTION OF THE DRAWINGS

FIG. 1 is a block diagram of a distributed energy resource (DER) subsystem according to some embodiments.

FIG. 2A is a block diagram of computing equipment configured to evaluate the possible designs of grounding equipment according to certain embodiments.

FIG. 2B is a block diagram of computing equipment configured to evaluate the possible designs of grounding equipment according to other embodiments.

FIG. 3 is a block diagram of grounding equipment design selection per equipment type according to some embodiments.

FIG. 4 is a block diagram of grounding equipment design selection per equipment type according to other embodiments.

FIG. 5 is a logic flow diagram of an iterative process performed by computing equipment for grounding equipment design selection according to some embodiments.

FIG. 6 is a block diagram of a user interface for system data entry of area EPS parameter values according to some embodiments.

FIGS. 7A-7F are graphs demonstrating the results of sensitivity analysis for one operating conditions as part of grounding equipment design selection according to some embodiments.

FIG. 8 is a block diagram of a sample executive summary report according to some embodiments.

FIG. 9 is a block diagram of a simplified sequence network diagram usable for analysis of effective system grounding according to some embodiments.

FIGS. 10A-10B are a logic flow diagram of a method for grounding equipment design selection according to some embodiments.

FIG. 11 is a logic flow diagram of a method performed by computing equipment according to some embodiments.

FIG. 12 is a block diagram of computing equipment according to some embodiments.

### DETAILED DESCRIPTION

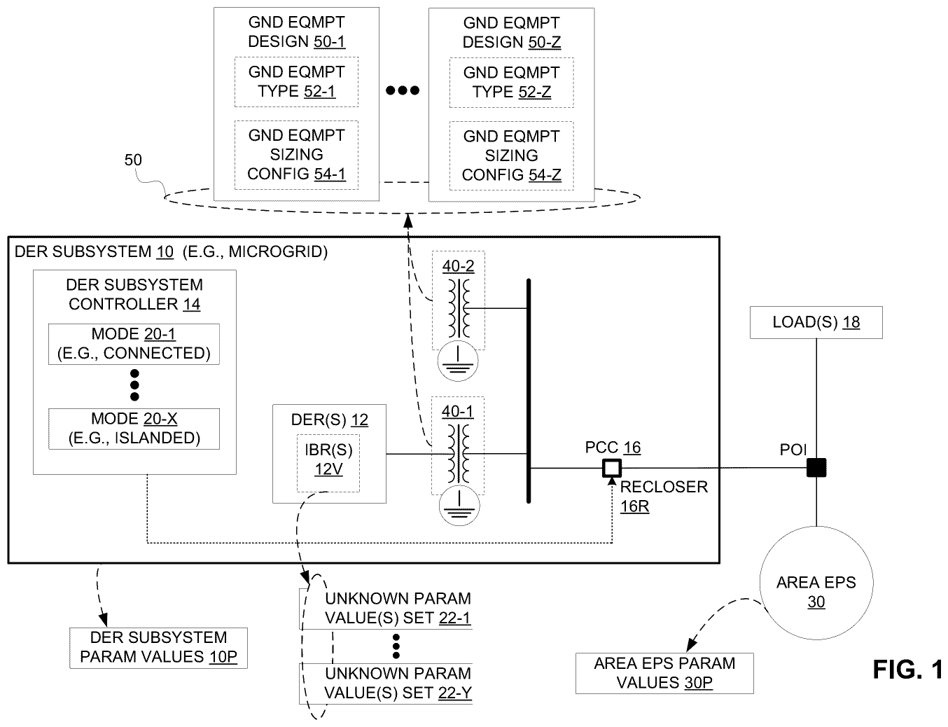

FIG. 1 shows a distributed energy resource (DER) subsystem 10 according to some embodiments. The DER subsystem 10 is a subsystem of one or more DERs 12. The DER(s) 12 include non-bulk electric resources that produce electricity and serve the DER subsystem 10. The DERs 12 may for example include solar photovoltaic (PV) panels, wind turbines, emergency backup generators, and/or combined heat and power systems. The DER(s) 12 may alternatively or additionally encompass energy storage technologies capable of exporting active power to the DER subsystem 10, such as battery energy storage systems (BESSs) or batteries in electric vehicles. As such, the DER subsystem 10 in some embodiments may be a self-sufficient electric power system (EPS) that is local. As one example, the DER subsystem 10 may be a microgrid or a nanogrid.

In some embodiments, the DER(s) 12 include one or more types of inverter-based resources (IBRs) 12V. An IBR is a resource based on an inverter, which is a power electronic device designed to convert direct current (DC) power into alternating current (AC) power, i.e., effectively inverting a rectifier's operation. Unlike synchronous generation, IBRs may exhibit different behavior in response to disturbances and as such may have uncharacterized fault current behavior.

The DER subsystem 10 in some embodiments is nonetheless capable of operating in conjunction with, or independently from, an external power system 30 while supplying one or more loads 18. Here, the external power system 30 may be an area EPS, e.g., where the area EPS may be an EPS that serves multiple local EPSs and/or may be a macrogrid or a utility grid. The capability of the DER subsystem 10 to operate in conjunction with, or independently from, the area EPS 30 may be realized by the DER subsystem 10 being able to selectively connect and disconnect from the area EPS 30, e.g., by way of a recloser 16R at a Point of Common Coupling (PCC) 16 between the DER subsystem 10 and the area EPS 30. When connected to the area EPS 30, the DER subsystem 10 may be said to operate in an area EPS connected mode, whereas when disconnected from the area EPS 30 the DER subsystem 10 may be said to operate in an islanded mode. In embodiments where the area EPS 30 is a macrogrid or utility grid, for example, such selective connection and disconnection may enable operation of the DER subsystem 10 in either grid-connected or islanded mode.

To support operation of the DER subsystem 10 in these and other embodiments, the DER subsystem 10 as shown includes a DER subsystem controller 14. The DER subsystem controller 14 is configured to control one or more aspects of the operation of the DER subsystem 10. For example, the DER subsystem controller 14 may be configured to control loading of the DER subsystem 10, such as by controlling load adjustments (e.g., load shedding, load curtailment, and/or load setpoints). The DER subsystem controller 14 as shown may also be configured to control in which of multiple possible modes 20-1 . . . 20-X of operation the DER subsystem 10 operates, e.g., by controlling reclosure 16R. These multiple possible modes 20-1 . . . 20-X of operation may be generally referred to as possible modes 20 of operation. The possible modes 20 of operation may for example include the area EPS connected mode in which the DER subsystem 10 is connected to the area EPS 30 and the islanded mode in which the DER subsystem 10 is islanded from the area EPS 30. In some embodiments, the possible modes 20 of operation may further include an unintentionally islanded mode (not shown) in which the DER subsystem 10 is transitioning from the area EPS connected mode to the islanded mode.

According to embodiments herein, multiple possible designs 50 exist as candidates for grounding equipment 40 that would provide neutral grounding of the DER subsystem 10. At least some of the different possible designs 50 may exploit different possible types of grounding equipment 40. For example, one possible type 40-1 of grounding equipment may be a DER subsystem transformer 40-1 that connects the DER subsystem 10 (or one or more of its DERs 12) to the area EPS 30 and that is also used for neutral grounding of the DER subsystem 10. A DER subsystem transformer 40-1 may for instance be a step-up transformer configured to increase a voltage level of DER(s) 12 to match a voltage level of the area EPS 30. By contrast, another possible type 40-2 of grounding equipment may be a dedicated grounding transformer (GT), or a dedicated bank of multiple grounding transformers, that is dedicated to or primarily purposed for neutral grounding of the DER subsystem 10. Generally, then, FIG. 1 shows multiple possible designs 50-1 . . . 50-Z of grounding equipment 40 for neutral grounding of the DER subsystem 10, where each possible design reflects a respective type 52-1 . . . 52-Z of grounding equipment 40. At least some of the types 52-1 . . . 52-Z of grounding equipment 40 reflected in the multiple possible designs 50-1 . . . 50-Z may be different from one another.

Alternatively or additionally, at least some of the different possible designs 50 may reflect different possible sizing configurations of grounding equipment 40, e.g., even among the same type of grounding equipment 40. In one such embodiment, different possible sizing configurations have at least some different values for one or more sizing parameters of grounding equipment 40. The sizing parameter(s) may for example include a neutral grounding resistance (NGR) parameter defining a neutral grounding resistance (NGR) of the grounding equipment 40 and/or a power rating parameter defining a power rating of the grounding equipment 40. Alternatively or additionally, the sizing parameter(s) may include a neutral grounding reactance parameter defining a neutral grounding reactance of the grounding equipment 40, an impedance parameter defining an impedance of the grounding equipment 40, a resistance parameter defining a resistance of the grounding equipment 40, or a reactance-to-resistance parameter defining a ratio of a reactance of the grounding equipment 40 to a resistance of the grounding equipment 40. No matter the particular nature of the different possible sizing configurations, then, FIG. 1 generally shows multiple possible designs 50-1 . . . 50-Z of grounding equipment 40 with each possible design reflecting a respective grounding equipment sizing configurations 54-1 . . . 45-Z. At least some of the sizing configurations 54-1 . . . 54-Z reflected in the multiple possible designs 50-1 . . . 50-Z may be different from one another.

Of course, these embodiments may be combined such that there may be different possible sizing configurations for each of multiple possible types of grounding equipment. In this case, the different possible combinations of sizing configurations and types of grounding equipment 40 may dictate the different possible grounding equipment designs 50-1 . . . 50-N.

In this context, some embodiments herein evaluate the appropriateness and effectiveness of multiple different possible designs 50 of grounding equipment 40, e.g., by evaluating how the different possible designs 50 of grounding equipment 40 would perform during a single-line-to-ground (SLG) fault at the PCC 16. In doing so, some embodiments account for the possibility that the DER subsystem 10 may operate in any of multiple possible modes 20-1 . . . 20-X of operation. That is, some embodiments evaluate the possible designs 50 of grounding equipment 40 for appropriateness across multiple possible modes of 20 of operation, rather than in only a single mode of operation. Alternatively or additionally, some embodiments account for the real-world practicality that the value(s) of some parameter(s) describing the DER subsystem 10 may be unknown. FIG. 1 in this regard shows that there may be different possible sets 22-1 . . . 22-Y of value(s) for one or more unknown parameters describing the DER subsystem 10. The unknown parameter(s) may for instance be associated with a negative-sequence impedance of the DER subsystem 10 according to a sequence components network and/or be attributable to IBRs 12V in the DER subsystem 10. Example unknown parameter(s) may include (i) a parameter defining an energy storage system (ESS) negative-sequence impedance, (ii) a parameter defining a ratio of a reactance to resistance (XR) of the ESS negative-sequence impedance (iii) a parameter defining a photovoltaic (PV) negative-sequence impedance, and/or (iv) a parameter defining a ratio of a reactance to resistance (XR) of the PV negative-sequence impedance. Regardless of the particular unknown parameters, though, some embodiments evaluate the possible designs 50 of grounding equipment 40 for appropriateness across the different possible sets 22-1 . . . 22-Y of value(s) for these unknown parameter(s). Grounding equipment design according to some embodiments herein thereby accounts for and is sensitive to the different possible sets 22-1 . . . 22-Y of value(s) for these unknown parameter(s), while mitigating over-dimensioning of the grounding equipment 40.

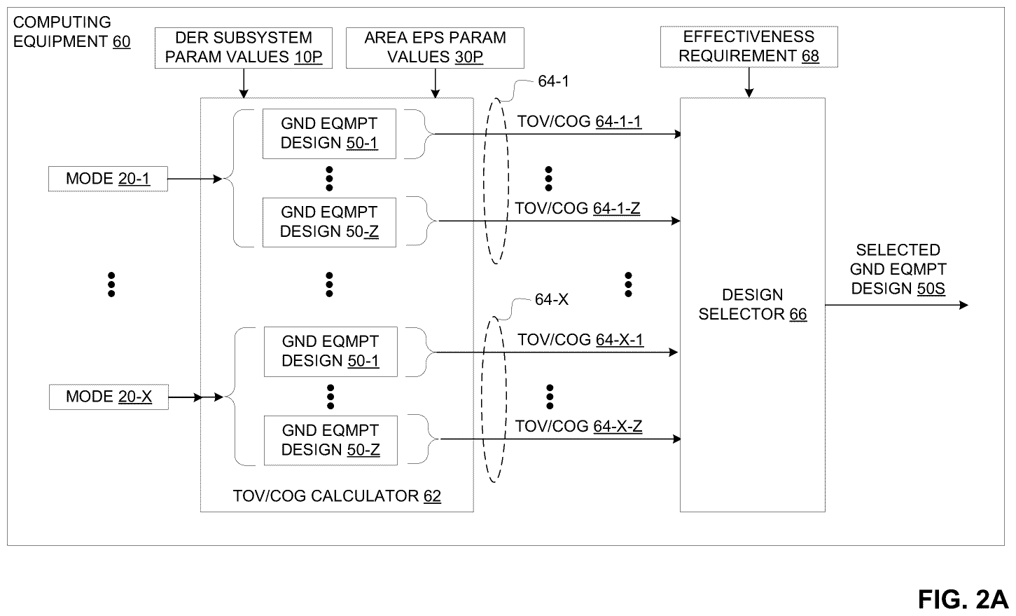

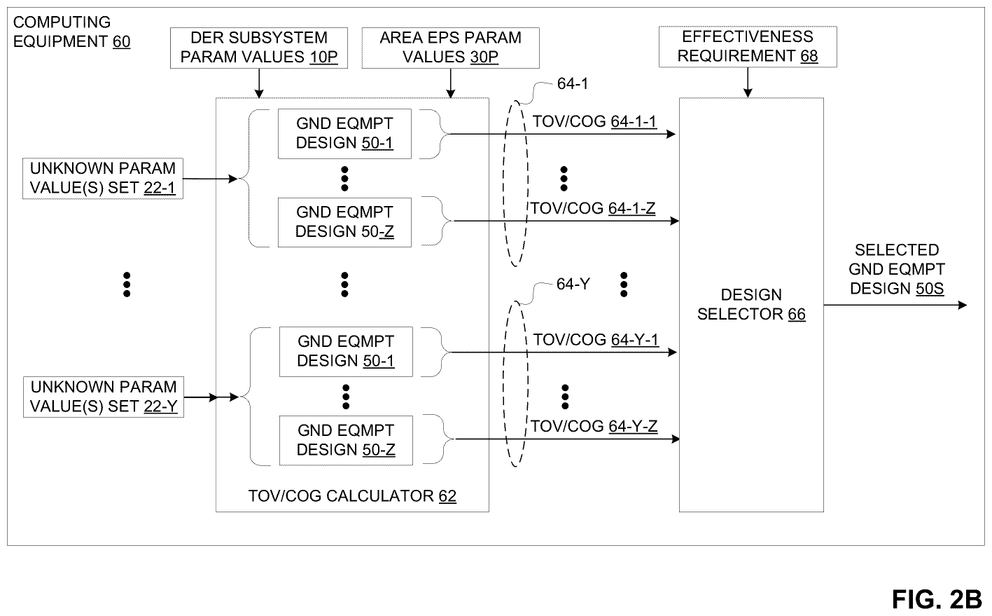

FIG. 2A illustrates computing equipment 60 configured to evaluate the possible designs 50 of grounding equipment 40 as candidates for use in the DER subsystem 10 according to some embodiments that account for the multiple possible modes 20-1 . . . 20-X of operation. As shown, the computing equipment 60 obtains values 30P of area EPS parameters describing the area EPS 30. The area EPS parameters may for example include a system voltage of the area EPS 30, a system frequency of the area EPS 30, a base capacity of the area EPS 30, a total load on the area EPS 30, a load power factor of the area EPS 30, a load imbalance percentage of the area EPS 30, a grounded load percentage of the area EPS 30, a grid positive-sequence impedance of the area EPS 30 at the PCC 16 between the DER subsystem 20 and the area EPS 30, a ratio of reactance to resistance (XR) of the grid positive-sequence impedance, a grid negative-sequence impedance of the area EPS 30 at the PCC 16; and a ratio of reactance to resistance of the grid negative-sequence impedance.

The computing equipment 60 also obtains values 10P of DER subsystem parameters describing the DER subsystem 10. In some embodiments, for example, the DER subsystem 10 includes one or more types of inverter-based resources 12V, e.g., including an ESS type and/or a photovoltaic (PV) type. In this case, the DER subsystem parameters may include, for each of the one or more types of inverter-based resources, a total loading associated with the type of inverter-based resources 12V, a total capacity of the type of inverter-based resources 12V, an inverter impedance of the type of inverter-based resources 12V, an impedance of a transformer that connects the type of inverter-based resources 12V to the area EPS 30, and/or a neutral grounding resistance of a transformer that connects the type of inverter-based resources 12V to the area EPS 30. Alternatively or additionally, the DER subsystem 10 may include one or more synchronous machine-based DERs. In this case, the DER subsystem parameters may include a positive-sequence impedance of the one or more synchronous machine-based DERs, a ratio of reactance to resistance of the positive-sequence impedance of the one or more synchronous machine-based DERs, a zero-sequence impedance of the one or more synchronous machine-based DERs, a ratio of reactance to resistance of the zero-sequence impedance of the one or more synchronous machine-based DERs, an impedance of a transformer that connects the one or more synchronous machine-based DERs to the area EPS 30, and/or a neutral grounding resistance of a transformer that connects the one or more synchronous machine-based DERs to the area EPS 30.

The computing equipment 60 as shown includes a temporary overvoltage (TOV) level and/or a coefficient of grounding (COG) calculator 62. For each of the multiple possible modes 20-1 . . . 20-X of operation of the DER subsystem 10, the TOV/COG calculator 62 calculates a TOV level and/or a COG (TOV/COG) 64 that would be associated with different possible designs 50 of grounding equipment 40 for neutral grounding of the DER subsystem 10. The TOV/COG calculator 62 calculates this based on the values 30P of the area EPS parameters and the values 10P of the DER subsystem parameters. Although not shown, the TOV/COG calculator 62 may calculate this also based on ground fault current level.

For the sake of illustration, FIG. 2A shows as an example of the TOV/COG calculator 62 calculating TOV/COG 64-1-1 through TOV/COG 64-1-Z (collectively, TOV/COG 64-1) that would be respectively associated with different possible grounding equipment designs 50-1 . . . 50-Z when the DER subsystem operates in mode 20-1 (e.g., area EPS connected mode). And the TOV/COG calculator 62 calculates TOV/COG 64-X−1 through TOV/COG 64-X-Z (collectively, TOV/COG 64-X) that would be respectively associated with different possible grounding equipment designs 50-1 . . . 50-Z when the DER subsystem operates in mode 20-X (e.g., islanded mode). And so on for any other modes of operation.

In some embodiments, the TOV/COG calculator 62 calculates the TOV/COG 64-1 . . . 64-X by exploiting a sequence component network for each possible mode 20 of operation of the DER subsystem 10, as neutrally grounded during an SLG fault by the grounding equipment 40. The TOV/COG calculator 62 in this regard may calculate the TOV/COG for each possible design 50 of the grounding equipment 40 as follows, for each possible mode 20 of operation. The TOV/COG calculator 62 calculates currents in the sequence component network for the possible mode 20 of operation of the DER subsystem 10, as neutrally grounded during the SLG fault by grounding equipment 40 designed according to the possible design 50. The TOV/COG calculator 62 may for example calculate the currents as a function of the values 30P of the area EPS parameters, the values 10P of the DER subsystem parameters, possible value(s) of the unknown parameter(s), and values of parameters defining the possible design 50 of the grounding equipment 40. The TOV/COG calculator 62 may then calculate, as a function of the currents and load sequence impedance in the sequence components network, sequence voltages at the PCC 16. The TOV/COG calculator 62 next calculates three-phase voltages at the PCC 16 as a function of the sequence voltages at the PCC 16. Finally, the TOV/COG calculator 62 calculates the TOV level as a maximum of the three-phase voltages and/or calculates the COG as the TOV level normalized to a line-to-line voltage at the PCC 16.

Regardless, the computing equipment 60 in FIG. 2A further includes a design selector 66. This design selector 66 effectively selects a design 50S from among the different possible grounding equipment designs 50-1 . . . 50-Z. The design selector 66 in doing so takes into account a requirement 68 that must be met concerning the effectiveness of the grounding equipment 40 for neutral grounding of the DER subsystem 10. The design selector 66 notably enforces this requirement for each of the possible modes 20-1 . . . 20-X of operation of the DER subsystem 10. The design selector 66 accordingly selects a design 50S that would comply with this requirement 68 across the multiple possible modes 20-1 . . . 20-X of operation of the DER subsystem 10 (at least if any of the possible designs 50-1 . . . 50-Z would so comply). That is, the design selector 66 selects a design 50S that complies with the requirement 68 for each of the possible modes 20-1 . . . 20-X of operation of the DER subsystem 10. For example, the design selector 66 may select grounding equipment design 50-1 if that design 50-1 complies with the effectiveness requirement 68 for each of the possible modes 20-1 . . . 20-X of operation of the DER subsystem 10.

The TOV/COG calculator 62 assists the design selector 66 in this regard by providing the design selector 66 with the calculated TOV levels and/or coefficients of grounding 64-1 . . . 64-X associated with the different possible grounding equipment designs 50-1 . . . 50-Z. So equipped, the design selector 66 determines, based on these calculated TOV levels and/or coefficients of grounding 64-1 . . . 64-X associated with the different possible grounding equipment designs 50-1 . . . 50-Z, a design 50S that would meet the requirement 68 on effectiveness of the grounding equipment 40 across the multiple possible modes 20-1 . . . 20-X of operation of the DER subsystem 10.

In some embodiments, for example, the effectiveness requirement 68 is that a COG associated with the grounding equipment 40 be below a COG threshold. In this case, the design selector 66 may compare the calculated COGs 64-1 . . . 64-X to the COG threshold. If a COG 64 calculated as being associated with a grounding equipment design 50 for a given mode 20 of operation is below the COG threshold, that grounding equipment design 50 complies with the effectiveness requirement 68 for that given mode. However, compliance with just a single mode 50 of operation is insufficient for selection, as compliance across the different possible modes 50 of operation is required. In this regard, if the COG 64 calculated as being associated with a grounding equipment design 50 for each mode 20 of operation is below the COG threshold, that grounding equipment design 50 complies with the effectiveness requirement 68 across the different possible modes 50 of operation. In the example of FIG. 2A, then, the design selector 66 may select grounding equipment design 50-1 if the COG 64-1-1 calculated as being associated with that grounding equipment design 50-1 for mode 20-1 falls below the COG threshold, and the COG 64-X−1 calculated as being associated with the grounding equipment design 50-1 for mode 20-X also falls below the COG threshold, and so on for each of the different possible modes 20-1 . . . 20-X.

Note of course that FIG. 2A shows the TOV/COG calculator 62 as exhaustively calculating the TOV/COG 64 associated with each grounding equipment design 50 for each mode 50 of operation. However, such exhaustive calculation may not be necessary for design selection, as the TOV/COG calculator 62 may be able to identify a design 50 that complies with the effectiveness requirement 68 across the different modes 50 of operation without having to calculate the TOV/COG 64 associated with each grounding equipment design 50 for each mode 50 of operation.

FIG. 2B shows a similar example that focuses on accounting for the different possible sets 22-1 . . . 22-Y of value(s) for the unknown parameter(s) describing the DER subsystem 10, rather than accounting for the different possible modes 20 of operation. Except as otherwise noted, the computing equipment 60 in FIG. 2B operates as described in FIG. 2A.

As shown in FIG. 2B, the TOV/COG calculator 62 calculates TOV/COG 64-1-1 through TOV/COG 64-1-Z (collectively, TOV/COG 64-1) that would be respectively associated with different possible grounding equipment designs 50-1 . . . 50-Z if the unknown parameter(s) describing the DER subsystem 10 were to have value(s) in set 22-1. And the TOV/COG calculator 62 calculates TOV/COG 64-Y−1 through TOV/COG 64-Y-Z (collectively, TOV/COG 64-Y) that would be respectively associated with different possible grounding equipment designs 50-1 . . . 50-Z if the unknown parameter(s) describing the DER subsystem 10 were to have value(s) in set 22-Y. And so on for any potential set 22-y of value(s) for the unknown parameter(s). In embodiments where the sets 22-1 . . . 2-Y of value(s) for the unknown parameter(s) reflect the inverter negative-sequence impedance, the TOV/COG calculates may advantageously cover substantially the entire range of the inverter negative-sequence impedance.

Rather than enforcing the effectiveness requirement 68 for each of the possible modes 20-1 . . . 20-X of operation of the DER subsystem 10, though, the design selector 68 enforces the effectiveness requirement 68 for each of the possible sets 22-1 . . . 22-Y of value(s) for the unknown parameter(s). The design selector 66 accordingly selects a design 50S that would comply with the effectiveness requirement 68 across the possible sets 22-1 . . . 22-Y of value(s) for the unknown parameter(s) (at least if any of the possible designs 50-1 . . . 50-Z would so comply). That is, the design selector 66 selects a design 50S that complies with the requirement 68 for each of the possible sets 22-1 . . . 22-Y of value(s) for the unknown parameter(s). For example, the design selector 66 may select grounding equipment design 50-1 if that design 50-1 complies with the effectiveness requirement 68 for each of the possible sets 22-1 . . . 22-Y of value(s) for the unknown parameter(s). Similarly as described with respect to modes 50 of operation in FIG. 2A, then, the design selector 66 determines, based on the calculated TOV levels and/or coefficients of grounding 64-1 . . . 64-X associated with the different possible grounding equipment designs 50-1 . . . 50-Z, a design 50S that would meet the requirement 68 on effectiveness of the grounding equipment 40 across the multiple possible sets 22-1 . . . 22-Y of value(s) for the unknown parameter(s).

Consider the example where the effectiveness requirement 68 is that a COG associated with the grounding equipment 40 be below an adjustable COG threshold. In this case, if a COG 64 calculated as being associated with a grounding equipment design 50 for a certain set 22-y of value(s) for the unknown parameter(s) is below the COG threshold, that grounding equipment design 50 complies with the effectiveness requirement 68 for that certain set 22-y of value(s) for the unknown parameter(s). However, compliance with respect to a single set 22-y of value(s) for the unknown parameters(s) is insufficient, as compliance across the multiple sets 22-1 . . . 22-Y of possible value(s) for the unknown parameter(s) is required. In this regard, if the COG 64 calculated as being associated with a grounding equipment design 50 for each of the sets 22-1 . . . 22-Y of value(s) for the unknown parameter(s) is below the COG threshold, that grounding equipment design 50 complies with the effectiveness requirement 68 across the different possible sets 22-1 . . . 22-Y of value(s) for the unknown parameter(s). In the example of FIG. 2B, then, the design selector 66 may select grounding equipment design 50-1 if the COG 64-1-1 calculated as being associated with that grounding equipment design 50-1 for set 22-1 of value(s) for unknown parameter(s) falls below the COG threshold, and the COG 64-Y−1 calculated as being associated with the grounding equipment design 50-1 for set 22-1 of value(s) for unknown parameter(s) also falls below the COG threshold, and so on for each of the different possible sets 22-1 . . . 22-Y of value(s) for unknown parameter(s).

Note again that FIG. 2B shows the TOV/COG calculator 62 as exhaustively calculating the TOV/COG 64 associated with each grounding equipment design 50 for each set of value(s) for unknown parameter(s). However, such exhaustive calculation may not be necessary for design selection, as the TOV/COG calculator 62 may be able to identify a design 50 that complies with the effectiveness requirement 68 across the different sets 22-1 . . . 2-Y of value(s) for unknown parameter(s) without having to calculate the TOV/COG 64 associated with each grounding equipment design 50 for each set 22-1 . . . 2-Y of value(s) for unknown parameter(s).

FIG. 2A focused on accounting for the different possible modes 20 of operation whereas FIG. 2B focused on accounting for the different possible sets 22-1 . . . 22-Y of value(s) for the unknown parameter(s) describing the DER subsystem 10. These embodiments may be combined so as to account for both the different possible modes 20 of operation and the different possible sets 22-1 . . . 22-Y of value(s) for the unknown parameter(s) in combination.

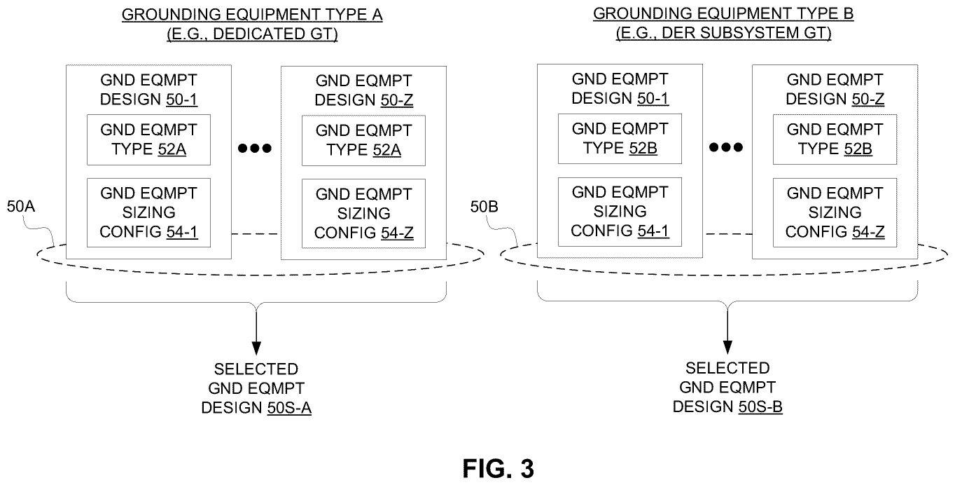

Note, too, that multiple grounding equipment designs 50 may be selected, e.g., one for each possible type of grounding equipment 40 considered. FIG. 3 for example shows that a subset 50A of grounding equipment designs 50 may each design grounding equipment 40 of a certain type A (e.g., as a dedicated grounding transformer, GT), so as to comprise grounding equipment type 52A. And another subset 50B of grounding equipment designs 50 may each design grounding equipment 40 of a different type B (e.g., re-using the DER subsystem transformer for neutral grounding), so as to comprise grounding equipment type 52B, In this case, one grounding equipment design 50S-A may be selected from among the subset 50A of grounding equipment designs 50 of a type A and another grounding equipment design 50S-B may be selected from among the subset 50B of grounding equipment designs 50 of a type B. Grounding equipment designs may thereby be selected on an equipment type by equipment type basis.

Moreover, some embodiments herein do not just select any grounding equipment design 50 that meets the effectiveness requirement 68. Indeed, in addition to compliance with the effectiveness requirement 68, some embodiments herein additionally consider the sizing configuration of the grounding equipment design 50 in the selection decision. Some embodiments for example select, from among one or more grounding equipment designs 50 that would meet the effectiveness requirement 68 across the multiple modes 50 of operation and/or across the multiple sets 22 of unknown parameter value(s), the grounding equipment design 50 that has the smallest sizing configuration. For example, in embodiments where the sizing configuration is defined by a neutral grounding resistance of the grounding equipment 40, this would mean selecting, from among one or more grounding equipment designs 50 that would meet the effectiveness requirement 68 across the multiple modes 50 of operation and/or across the multiple sets 22 of unknown parameter value(s), the grounding equipment 50 design that has the smallest neutral grounding resistance. Or, in another example, in embodiments where the sizing configuration is defined by a power rating of the grounding equipment 40, this would mean selecting, from among one or more grounding equipment designs 50 that would meet the effectiveness requirement 68 across the multiple modes 50 of operation and/or across the multiple sets 22 of unknown parameter value(s), the grounding equipment 50 design that has the smallest power rating. Other parameters that may impact how small a grounding equipment's sizing configuration is may include: (i) a neutral grounding reactance parameter defining a neutral grounding reactance of the grounding equipment; (ii) an impedance parameter defining an impedance of the grounding equipment; (iii) a resistance parameter defining a resistance of the grounding equipment; and/or (iv) a reactance-to-resistance parameter defining a ratio of a reactance of the grounding equipment to a resistance of the grounding equipment.

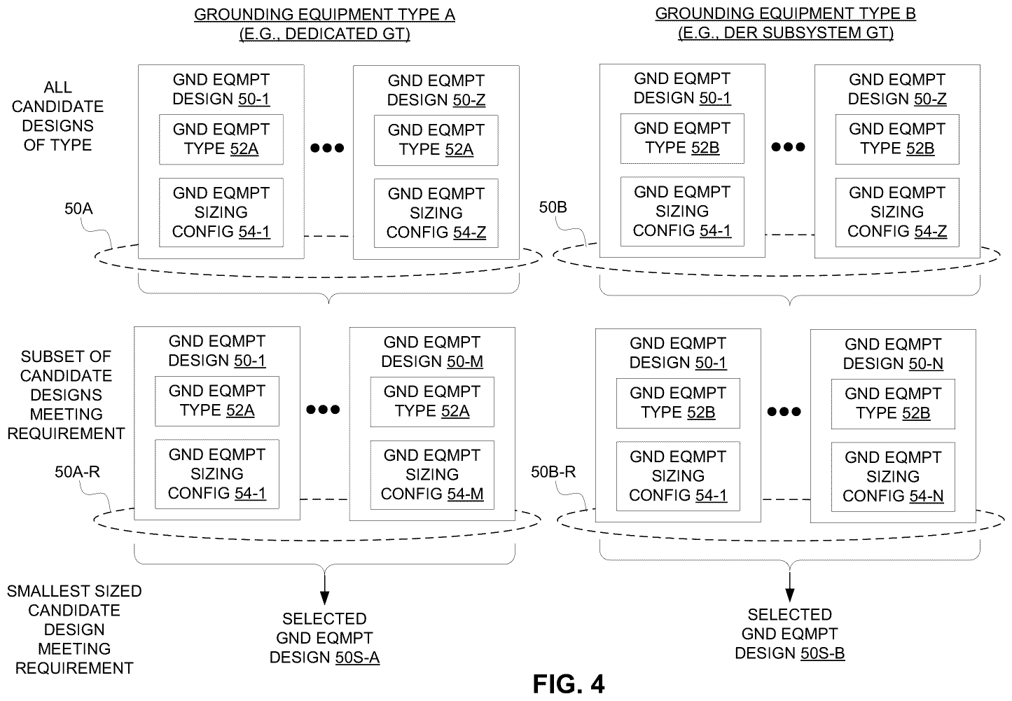

FIG. 4 shows that, again, this may be performed on a type by type basis, with the smallest sized candidate design meeting the effectiveness requirement 68 being selected for each possible equipment type considered. FIG. 4 for example shows that, from among the candidate grounding equipment designs 50A of type A, a subset 50A-R of those grounding equipment designs 50A meet the effectiveness requirement 68 across the multiple modes 50 of operation and/or across the multiple sets 22 of unknown parameter value(s). Whichever grounding equipment design in this subset 50A-R has the smallest size configuration is selected as the grounding equipment design 50S-A for type A grounding equipment 40. Similarly, from among the candidate grounding equipment designs 50B of type B, a subset 50B-R of those grounding equipment designs 50B meet the effectiveness requirement 68 across the multiple modes 50 of operation and/or across the multiple sets 22 of unknown parameter value(s). Whichever grounding equipment design in this subset 50B-R has the smallest size configuration is selected as the grounding equipment design 50S-B for type B grounding equipment 40.

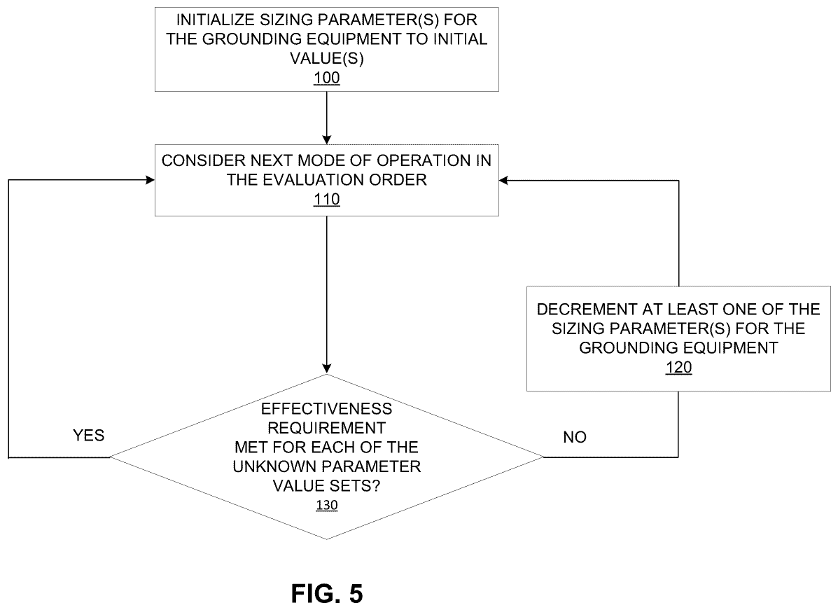

The computing equipment 60 in some embodiments may exploit an iterative process to determine, for each type of grounding equipment, the grounding equipment design with the smallest size configuration that meets the effectiveness requirement 68 across the multiple modes 50 of operation and/or across the multiple sets 22 of unknown parameter value(s). FIG. 5 shows one example of such a process.

In the example of FIG. 5, the different possible modes 50 of operation of the DER subsystem 10 are successively ordered in an evaluation order. The evaluation order may for example evaluate the area EPS connected mode first, then the islanded mode, and then (if considered) the unintentionally islanded mode. The computing equipment 60 first initializes sizing parameter(s) for grounding equipment 40 of a certain type, e.g., a dedicated grounding transformer (Block 100). The sizing parameter(s) may for instance be a neutral grounding resistance of the grounding equipment 40. In some embodiments, the initial value(s) are calculated based on the values 30P of the area EPS parameters and the values 10P of the DER subsystem parameters. The computing equipment 60 then considers the next mode of operation in the evaluation order (Block 110), which for the first iteration is the first mode of operation in the evaluation order. For this considered mode, the computing equipment 60 determines if the grounding equipment as sized according to the sizing parameters would meet the effectiveness requirement 68 across the set(s) 22 of unknown parameter value(s) (Block 130). Where the effectiveness requirement 68 is that the COG is less than a COG threshold, this means that the computing equipment 60 determines if the COG associated with the grounding equipment as sized according to the sizing parameters would fall below the COG threshold for each of the set(s) 22 of unknown parameter value(s). If not (NO at Block 130), the computing equipment 60 decrements at least one of the sizing parameter(s) (Block 120) and re-considers (in Block 130) whether the re-sized grounding equipment would meet the effectiveness requirement 68 across the set(s) 22 of unknown parameter value(s). The computing equipment 60 thereby iteratively decrements at least one of the sizing parameter(s), as needed, until the effectiveness requirement 68 is met across the set(s) 22 of unknown parameter value(s), e.g., unless the COG associated with the grounding equipment as sized according to the sizing parameters would fall below the COG threshold for each of the set(s) 22 of unknown parameter value(s).

If and when this occurs for the currently considered mode of operation, the computing equipment 60 considers the next mode of operation in the evaluation order (Block 110). For one or more subsequent modes of operation, the computing equipment 60 continues the evaluation described above, starting from the sizing parameter(s) resulting from the previous iteration.

By iteratively decrementing the sizing configuration in this way, the computing equipment 60 identifies the most appropriately-sized grounding equipment 40 while still ensuring compliance with the effectiveness requirement 68 across each of the modes 20 of operation and/or each of the set(s) 22 of unknown parameter value(s). This may prove advantageous especially in the case that the set(s) 22 of unknown parameter value(s) are associated with negative-sequence impedance of the DER subsystem 10 and/or attributable to inverter-based resources in the DER subsystem 10. Some embodiments thereby advantageously enable neutral grounding design for inverter-based DER subsystems in a way that avoids over-dimensioned grounding equipment, which in turn reduces costs, improves system protection, and enhances personnel safety.

In some embodiments, the computing equipment 60 validates the determined design 50 of grounding equipment 40, e.g., using a power-flow analysis of a single-line-to-ground (SLG) fault at the PCC 16.

Either way, having determined the design 50 of grounding equipment as described above, the computing equipment 60 in some embodiments provide an indication of the determined design 50, e.g., on a user interface of the computing equipment 60 or other equipment not shown. The indication may for instance represent the determined design 50 as being proposed for the grounding equipment 40. In fact, the indication may even represent the determined design 50 as being optimal or best for the grounding equipment 40.

In some embodiments, the computing equipment 60 alternatively or additionally provides a graphical representation (e.g., on the user interface) illustrating the TOV level and/or COG that would be associated with the determined design 50 of grounding equipment 40. In some embodiments, the graphical representation illustrates this TOV level and/or COG as a function of a sizing configuration of the grounding equipment 40. This assists the user to understand any potential relationship or tradeoff between the sizing of the grounding equipment 40 and the effectiveness of the grounding equipment 40.

In some embodiments, this information may be provided in the form of an engineering report with required sizing parameters that can be used for ordering (procurement) and implementation of the determined design 50.

Consider now an example implementation of some embodiments herein as a hardware and/or software tool configured to provide a user with a series of interfaces and graphical visualization schemes for designing an effective neutral grounding method for DER interconnection. The tool is configured to perform TOV calculations with acceptable authenticity to cover various possible system conditions and parameters. This tool is configured to carry out a sensitivity analysis to account for changes in unknown system parameters and to provide a report on the sizing and analysis. Notably, it may be used for both conventional rotating-machine-based DERs and inverter-based DERs. The design and calculations are done through four steps in this tool.

STEP 1: A systematic data collection and data entry structure forms an interacting environment for the user to enter the required data of the DER and the connecting area Electrical Power System (EPS). Some embodiments include obtaining values 30P of one or more area EPS parameters describing the area EPS 30 and/or values 10P of one or more DER parameters describing the DER subsystem 10, including one or more of:
General System Parameters:
   System voltage (kV)
   System frequency (Hz)
   Base capacity (MVA)
Inverter-Based Resources (IBRs)
   1. DER type information-Energy Storage System (ESS):
      ESS (Present/Absent)
      Total ESS loading (MVA)
      Total ESS capacity (MVA)
      ESS inverter impedance (p.u.)
      ESS transformer impedance (p.u.)
      ESS transformer neutral grounding resistance ((2)
   2. DER type-Solar PV inverters:
      PV inverter (Present/Absent)
      Total PV associated loading (MVA)
      Total PV inverter capacity (MVA)
      PV inverter impedance (p.u.)
      PV transformer impedance (p.u.)
      PV transformer NGR resistance (Ω)
Synchronous Machine Based DER:
   Generator (Present/Absent)
   Generator positive-sequence impedance (p.u.)
   Generator positive-sequence impedance X/R ratio
   Generator zero-sequence impedance (p.u.)
   Generator zero-sequence impedance X/R ratio
   Generator transformer impedance (p.u.)
   Generator transformer NGR resistance (Ω)
Load:
   Total Load (MVA)—on associated area
   Load power factor
   Load imbalance percentage (%)
   Grounded load percentage (%)
Utility Grid (Area EPS) data at the Point of Common Coupling (PCC):
   Grid positive sequence impedance (Ω)
   Grid positive sequence impedance X/R ratio
   Grid negative-sequence impedance (Ω)
   grid positive sequence impedance of the area EPS at a Point of Common Coupling (PCC) between the DER subsystem and the area EPS;
Grounding Transformer—if any existing or determined:
   Grounding transformer impedance (p.u.)
   Grounding transformer impedance X/R ratio
   Grounding transformer neutral resistance (Ω)
   Grounding transformer neutral reactance (Ω)

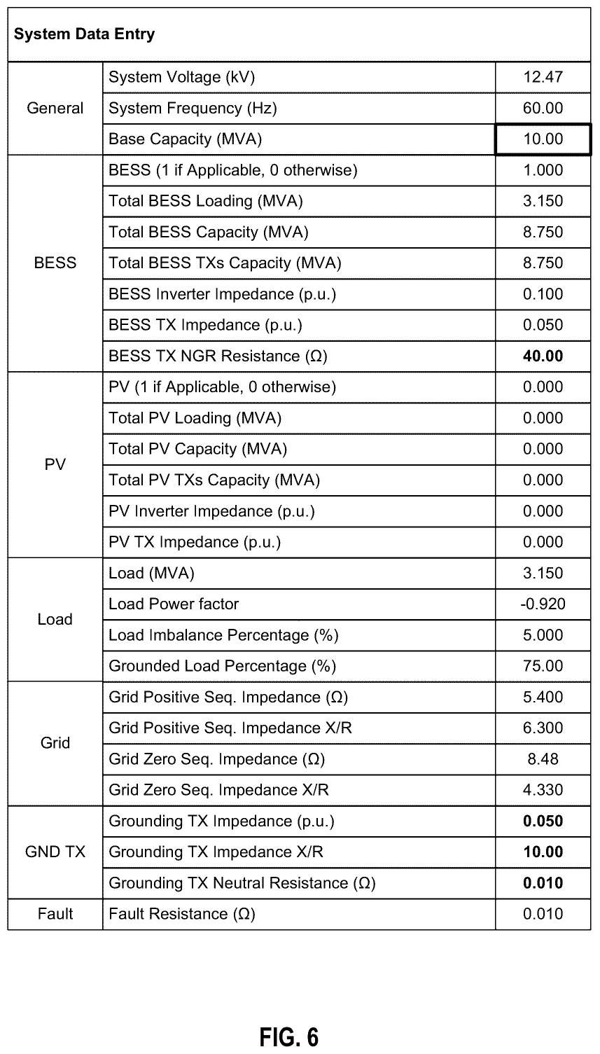

FIG. 6 demonstrates a sample user interface of the tool for user data entry of the values 30P of the area EPS parameters and the values 10P of the DER subsystem parameters in some embodiments.

STEP 2: The entered data of the DER and the area EPS is used by the tool to build and analyze the sequence components network for Single-Line-to-Ground (SLG) faults at the PCC 16 of the interconnection project. Note that SLG on area EPS is the worst-case scenario for evaluating TOV. The computations engine of the tool will solve this circuit considering two or more of the system conditions from among: (a) Grid-connected mode; (b) Island Mode (if applicable); and (c) Un-planned islanding (if applicable).

The tool also considers system parameters associated with the DER type and topology, including one or more of:
1. Various ESS negative-sequence impedances
2. Defined X/R ratio of the ESS negative-sequence impedance
3. ESS transformer NGR resistance
4. PV negative-sequence impedance
5. Synchronous generator transformer impedance
6. Synchronous generator transformer neutral grounding impedance
7. X/R ratio of the PV negative-sequence impedance
8. Grounding transformer impedance
9. X/R ratio of the grounding transformer Impedance
10. Grounding transformer neutral grounding resistor resistance
11. Ans similar data for other types of DER

STEP 3: The tool first determines the size of the grounding bank (for the design based on a separate grounding bank—Method 2 below) or the required ground impedance. Then, it runs multiple sensitivity analysis, e.g., to account for uncertainty about inverter-based resources. In each analysis, the tool calculates the level of TOVs with respect to the DER inverter negative-sequence variation of Inverter-Based Resources (IBRs) from 100 pu to 0.1 pu while focusing on specific parameters such as:
a. X/R ratio of the inverters negative-sequence impedance
b. ESS transformer Neutral Grounding resistance (NGR) or reactance (NGX)
c. Grounding transformer impedance
d. X/R ratio of the grounding transformer Impedance

This sensitivity analysis is one example of accounting for different sets of value(s) for unknown parameter(s) described before.

The tool is configured to run multiple analysis to cover the sensitivity of the TOV levels to all of the DER parameters under the three system conditions including grid-connected mode, (planned) island mode, and unplanned islanding. Some study cases analyze the possibility/effectivity of using the grounding bank for grounding while the rest focus on the second grounding method, which is using the available neutral of the ESS step-up transformers.

The tool may provide a graphical view of the outcomes of the analysis through one or more graphs, each to present variations in the level of system TOV versus one or two parameters listed above. These graphs according to some embodiments are listed below:
Method 1—Effective grounding without grounding transformer:
   TOV vs. Inverters Z2, where Z2 is the negative-sequence impedance of a DER.
   Three graphs are used to verify the impact of different X/R ratio levels of the inverters negative-sequence impedance including 10, 1, and 0.1
   TOV vs. Inverters Z2.
   Three graphs are used to verify the impact of three different levels of the ESS neutral grounding resistance.
Method 2—Effective grounding with grounding transformer:
   TOV vs. Inverters Z2.
   Three graphs are used to verify the impact of different X/R ratio levels of the inverters negative-sequence impedance including 10, 1, and 0.1
   TOV vs. Inverters Z2.
   Three graphs are used to verify the impact of three different levels grounding transformer X/R ratio considering entered value of the grounding transformer impedance
   TOV vs. Inverters Z2.
   Three graphs are used to verify the impact of for three different levels grounding transformer X/R ratio considering 150% of the entered value of the grounding transformer impedance
   TOV vs. Inverters Z2.
   Three graphs are used to verify the impact of three different levels grounding transformer neutral-to-ground resistance

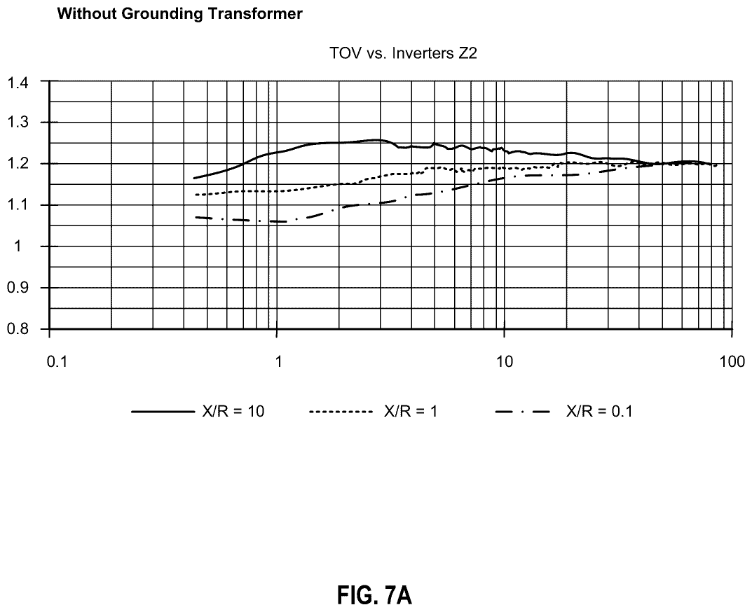

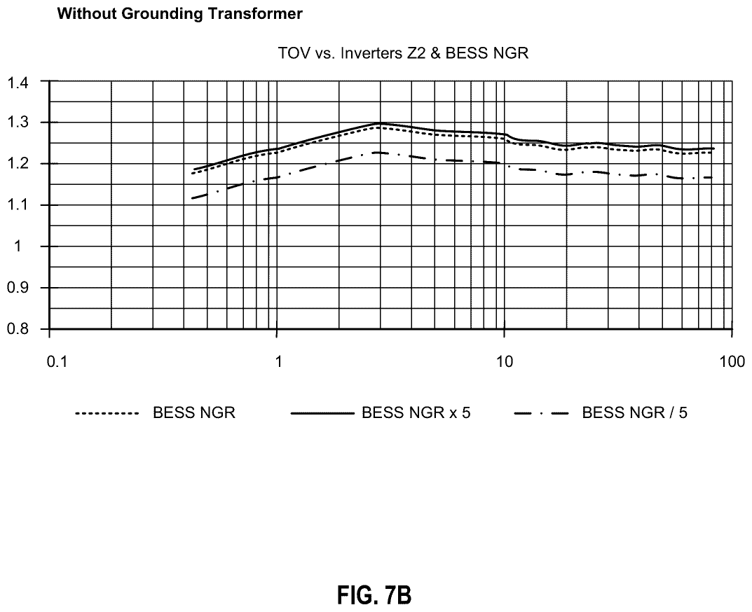

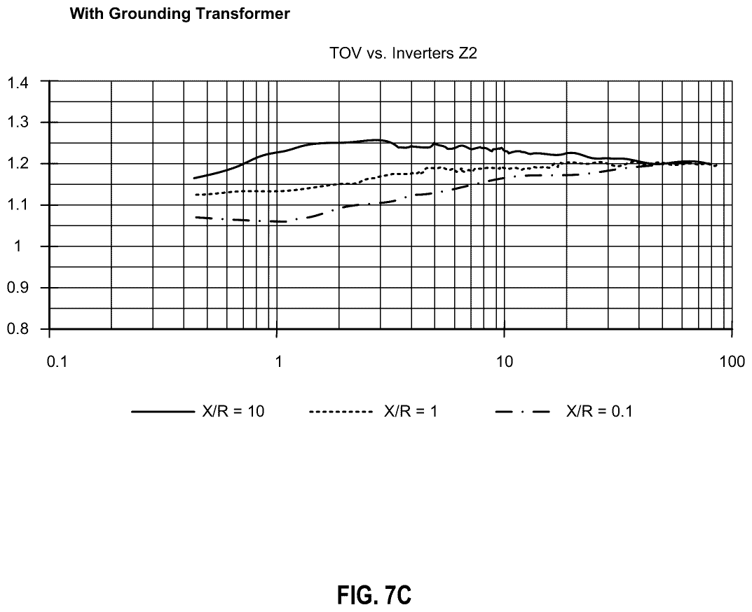

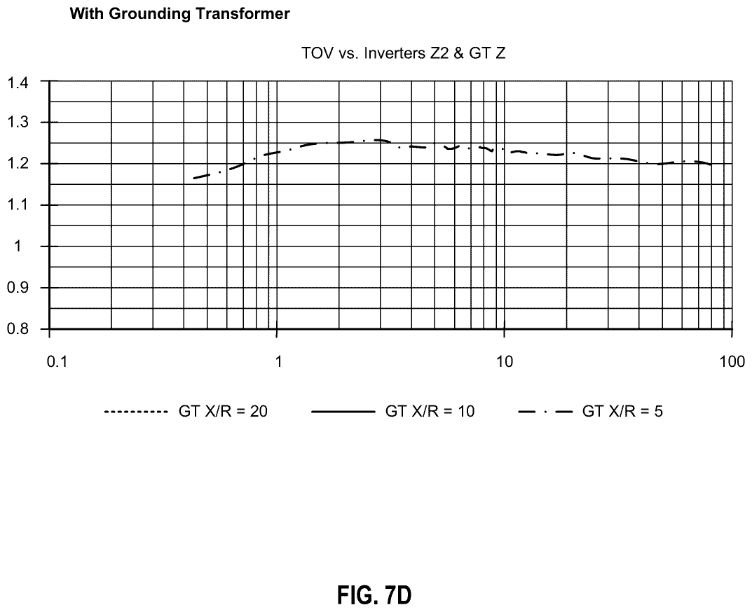

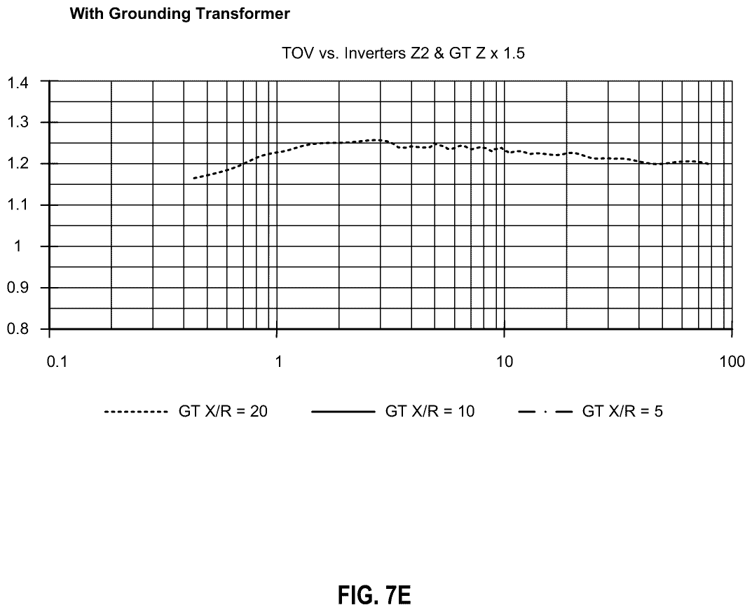

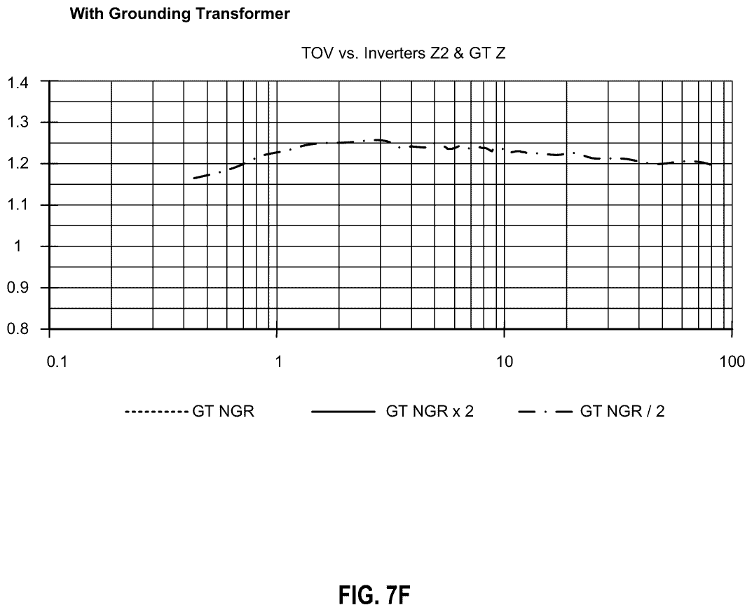

FIGS. 7A-7E show sample representation of the analytical and sensitivity analysis relayed graphs according to some embodiments. Indeed, these six sample graphs demonstrate the results of the sensitivity analysis for one operating condition.

Further, in some embodiments, the tool uses the results demonstrated in these graphs together with further calculations to provide an executive summary report that describes (i) if any of the grounding methods is acceptable; (ii) a maximum level of COG and TOV for both grounding methods; and/or (iii) the grounding parameters being acceptable, e.g., based on effective grounding requirements of IEEE Std. C62.92.1.

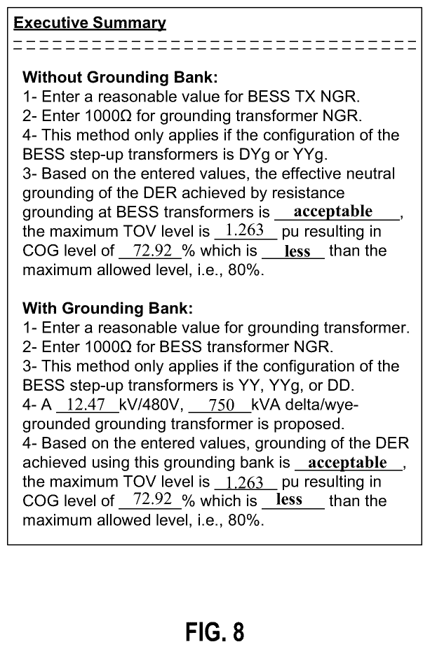

This step thereby provides the user with enough technical information about each grounding method and helps him or her with selection. A sample executive summary report is shown in FIG. 8.

STEP 4: The tool may also provide a final report that contains: (i) sizing of the grounding equipment such as the grounding transformer, or Neutral Grounding Resistor (NGR); (ii) one or more graphs to show the expected level of the TOVs versus different system parameters for the final design; and/or (iii) a conclusion of the analysis to indicate if the grounding method(s) with the entered parameters are acceptable or not.

Some embodiments herein accordingly include a method of designing grounding equipment to account for interconnection of a distributed energy resource (DER) subsystem to an area electric power system (EPS).

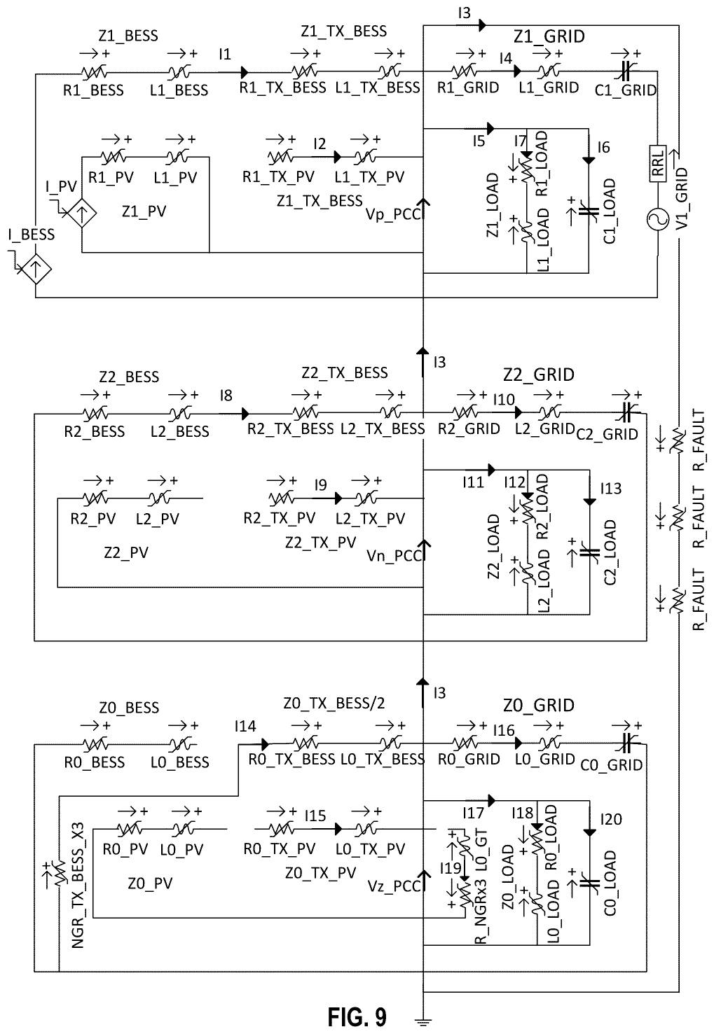

Consider now a detailed example of some embodiments that exploit sequence components network analysis for grounding equipment design during a ground fault condition. FIG. 9 shows a simplified sequence network diagram usable for analysis of the effective system grounding in some embodiments. As can be seen, most of the system parameters are defined as variable parameters. This is to consider the impact of unknown values for an inverter-based resource (more specifically, negative sequence equivalents). The complete list of the internal variables as well as their default values and brief description are included in Table 1 below.

TABLE 1
Internal Variables

| Equipment | Parameter | Unit | Default | Description/Equation |
|---|---|---|---|---|
| System | S_{base} | MVA | 10.00 | Base MVA. Always use 10 MVA. |
| | Z_{base} | Ω | 1.000 | V_{LL}² / S_{base} |
| BESS | I_{BESS} | p.u. | 1.000 | S_{BESS} / S_{Load} |
| | R1_{BESS} | p.u. | 0.026 | 0.026 × (S_{base} / S_{BESS}) × XR_{BESS} |
| | L1_{BESS} | H | 0.001 | 0.026 × (S_{base} / S_{BESS}) / 2πf |
| | XL1_{BESS} | Ω | 0.100 | 2πf × L1_{BESS} |
| | Z1_{BESS} | Ω | 0.100 | R1_{BESS} + j XL1_{BESS} |
| | R1_{BESS} | p.u. | 0.026 | SLIDER1 × (S_{base} / S_{BESS}) × XR_{BESS} |
| | L1_{BESS} | H | 0.001 | SLIDER1 × (S_{base} / S_{BESS}) / 2πf |
| | XR_{BESS} | NA | 10 | 0.1, 1, 10, 20 |
| | XL2_{BESS} | Ω | 0.100 | 2πf × L2_{BESS} |
| | Z2_{BESS} | Ω | 0.100 | R2_{BESS} + j XL2_{BESS} |
| | R0_{BESS} | p.u. | 0.026 | 0.026 × (S_{base} / S_{BESS}) × XR_{BESS} |
| | L0_{BESS} | H | 0.001 | 0.026 × (S_{base} / S_{BESS}) / 2πf |
| | XL0_{BESS} | Ω | 0.100 | 2πf × L0_{BESS} |
| | Z0_{BESS} | Ω | 0.100 | R0_{BESS} + j XL0_{BESS} |
| | SLIDER1 | p.u. | 100.0 | 100 to 0.2 |
| | R1_{BESS-TX} | p.u. | 0.010 | 0.05 × (S_{base} / S_{BESS-TX}) × 0.1 |
| | L1_{BESS-TX} | H | 0.001 | 0.05 × (S_{base} / S_{BESS-TX}) / 2πf |
| | XL1_{BESS-TX} | Ω | 0.100 | 2πf × L1_{BESS-TX} |
| | Z1_{BESS-TX} | Ω | 0.100 | R1_{BESS-TX} + j XL1_{BESS-TX} |
| | R2_{BESS-TX} | p.u. | 0.010 | 0.05 × (S_{base} / S_{BESS-TX}) × 0.1 |
| | L2_{BESS-TX} | H | 0.001 | 0.05 × (S_{base} / S_{BESS-TX}) / 2πf |
| | XL2_{BESS-TX} | Ω | 0.100 | 2πf × L2_{BESS-TX} |
| | Z2_{BESS-TX} | Ω | 0.100 | R2_{BESS-TX} + j XL2_{BESS-TX} |
| | R0_{BESS-TX} | p.u. | 0.010 | 0.05 × (S_{base} / S_{BESS-TX}) × 0.1 |
| | L0_{BESS-TX} | H | 0.001 | 0.05 × (S_{base} / S_{BESS-TX}) / 2πf |
| | XL0_{BESS-TX} | Ω | 0.100 | 2πf × L0_{BESS-TX} |
| | Z0_{BESS-TX} | Ω | 0.100 | R0_{BESS-TX} + j XL0_{BESS-TX} |
| | R_{NGR-BESS-TX} | Ω | 1.000 | SLIDER2 |
| | SLIDER2 | Ω | 1.000 | 0.1, 1, 2, 5, 10, 20, 30, 40, 50, 100 |
| _{PV} | I_{PV} | p.u. | 0.000 | S_{PV} / S_{Load} |
| | R1_{PV} | p.u. | 0.026 | 0.026 × (S_{base} / S_{PV}) × XR_{PV} |
| | L1_{PV} | H | 0.001 | 0.026 × (S_{base} / S_{PV}) / 2πf |
| | XL1_{PV} | Ω | 0.100 | 2πf × L1_{PV} |
| | Z1_{PV} | Ω | 0.100 | R1_{PV} + j XL1_{PV} |
| | R2_{PV} | p.u. | 0.026 | SLIDER3 × (S_{base} / S_{PV}) × XR_{PV} |
| | L2_{PV} | H | 0.001 | SLIDER3 × (S_{base} / S_{PV}) / 2πf |
| | XR_{PV} | NA | 10 | 0.1, 1, 10, 20 |
| | XL2_{PV} | Ω | 0.100 | 2πf × L2_{PV} |
| | Z2_{PV} | Ω | 0.100 | R2_{PV} + j XL2_{PV} |
| | R0_{PV} | p.u. | 0.026 | 1000 × (S_{base} / S_{PV}) × XR_{PV} |
| | L0_{PV} | H | 100.0 | 1000 × (S_{base} / S_{PV}) / 2πf |
| | XL0_{PV} | Ω | 100.0 | 2πf × L0_{PV} |
| | Z0_{PV} | Ω | 100.0 | R0_{PV} + j XL0_{PV} |
| | SLIDER3 | p.u. | 100.0 | 100 to 0.2 |
| | R1_{PV-TX} | p.u. | 0.010 | 0.03 × (S_{base} / S_{PV-TX}) × 0.1 |
| | L1_{PV-TX} | H | 0.001 | 0.03 × (S_{base} / S_{PV-TX}) / 2πf |
| | XL1_{PV-TX} | Ω | 0.100 | 2πf × L1_{PV-TX} |
| | R2_{PV-TX} | p.u. | 0.010 | 0.03 × (S_{base} / S_{PV-TX}) × XR_{PV} |
| | L2_{PV-TX} | H | 0.001 | 0.03 × (S_{base} / S_{PV-TX}) / 2πf |
| | XL2_{PV-TX} | Ω | 0.100 | 2πf × L2_{PV-TX} |
| | R0_{PV-TX} | p.u. | 0.010 | 0.03 × (S_{base} / S_{PV-TX}) × XR_{PV} |
| | L0_{PV-TX} | H | 0.001 | 0.03 × (S_{base} / S_{PV-TX}) / 2πf |
| | XL0_{PV-TX} | Ω | 0.100 | 2πf × L0_{PV-TX} |
| Load | R1_{Load} | p.u. | 115.0 | (V_{LL}² / S_{LOAD}) × PF / Z_{base} |
| | L1_{Load} | H | 0.001 | (V_{LL}² / S_{LOAD}) × sin(cos⁻¹ PF) / 2πf / Z_{base}, if PF > 0 |
| | C1_{Load} | μF | 2.000 | 10⁶ / [(V_{LL}² / S_{LOAD}) × sin(cos⁻¹ PF) × 2πf / Z_{base}], if PF < 0 |
| | R2_{Load} | p.u. | 115.0 | (V_{LL}² / S_{LOAD}) × PF / Z_{base} |
| | L2_{Load} | H | 0.001 | (V_{LL}² / S_{LOAD}) × sin(cos⁻¹ PF) / 2πf / Z_{base}, if PF > 0 |
| | C2_{Load} | μF | 2.000 | 10⁶ / [(V_{LL}² / S_{LOAD}) × sin(cos⁻¹ PF) × 2πf / Z_{base}], if PF < 0 |
| | R0_{Load} | p.u. | 115.0 | (V_{LL}² / S_{LOAD}) × PF / Z_{base} |
| | L0_{Load} | H | 0.001 | (V_{LL}² / S_{LOAD}) × sin(cos⁻¹ PF) / 2πf / Z_{base}, if PF > 0 |
| | C0_{Load} | μF | 2.000 | 10⁶ / [(V_{LL}² / S_{LOAD}) × sin(cos⁻¹ PF) × 2πf / Z_{base}], if PF < 0 |
| Grid | R1_{Grid} | p.u. | 0.560 | Z1_{Grid} × cos (tan⁻¹ (X1/R1_{Grid})) / Z_{base} |
| | L1_{Grid} | H | 0.001 | Z1_{Grid} × sin (tan⁻¹ (X1/R1_{Grid})) / 2πf / Z_{base}, if PF > 0 |
| | C1_{Grid} | μF | 2.000 | 10⁶ / [Z1_{Grid} × sin (tan⁻¹ (X1/R1_{Grid})) × 2πf / Z_{base}], if PF < 0 |
| | R2_{Grid} | p.u. | 0.560 | Z1_{Grid} × cos (tan⁻¹ (X1/R1_{Grid})) / Z_{base} |
| | L2_{Grid} | H | 0.001 | Z1_{Grid} × sin (tan⁻¹ (X1/R1_{Grid})) / 2πf / Z_{base}, if PF > 0 |
| | C2_{Grid} | μF | 2.000 | 10⁶ / [Z1_{Grid} × sin (tan⁻¹ (X1/R1_{Grid})) × 2πf / Z_{base}], if PF < 0 |
| | R0_{Grid} | p.u. | 7.480 | Z0_{Grid} × cos (tan⁻¹ (X1/R1_{Grid})) / Z_{base} |
| | L0_{Grid} | H | 0.001 | Z0_{Grid} × sin (tan⁻¹ (X1/R1_{Grid})) / 2πf / Z_{base}, if PF > 0 |
| | C0_{Grid} | μF | 2.000 | 10⁶ / [Z0_{Grid} × sin (tan⁻¹ (X1/R1_{Grid})) × 2πf / Z_{base}], if PF < 0 |
| Grounding | R_{GT} | p.u. | 0.010 | SLIDER4 × cos (tan⁻¹ (SLIDER4)) × (S_{base} / S_{GT}) |
| Transformer | L_{GT} | H | 0.001 | SLIDER4 × sin (tan⁻¹ (SLIDER4)) × (S_{base} / S_{GT}) / 2πf |
| | XL_{GT} | Ω | 100.0 | 2πf × L_{GT} |
| | Z_{GT} | p.u. | | R_{GT +} j XL_{GT} |
| | XR_{GT} | NA | 10 | 4, 6, 10 |
| | SLIDER4 | p.u. | 20.0 | 0.02, 0.03, 0.05, and 0.07 |
| | R_{NGR-GT} | p.u. | 0.001 | SLIDER5 / Z_{base} |
| | SLIDER5 | Ω | 0.100 | 0.1 |

The tool engine as implemented by the computing equipment 10 solves the sequence components network circuit shown in FIG. 9 in the phasor domain. To do so, the current of twenty branches, namely I1 through I20, are calculated using a circuit impedance matrix. The matrix Z of the circuit is used in Equation (1) and Equation (2) below to calculate the twenty current phasors as below.

$$Z \times I = V \qquad Eq . ( 1 )$$

$$I = {Z}^{- 1} V \qquad Eq . ( 2 )$$

Once the I1 through I20 are calculated using Equation (2), the positive-, negative-, and zero-sequence voltages at the PCC 16 be calculated.

$$V {1}_{PCC} = ( R {1}_{Load} + jXL {1}_{Load} ) \times {I}_{7} \qquad Eq . ( 3 )$$

$$V {2}_{PCC} = ( R {2}_{Load} + jXL {2}_{Load} ) \times {I}_{12} \qquad Eq . ( 4 )$$

$$V {0}_{PCC} = ( R {0}_{Load} + jXL {0}_{Load} ) \times {I}_{18} \qquad Eq . ( 5 )$$

Having the sequence voltages calculated, the three-phase voltages are obtained as below.

$${V}_{AG} = {V}_{AG - Real} + {V}_{AG - Imag} = ( V {1}_{PCC - Real} + V {2}_{PCC - Real} + V {0}_{PCC - Real} ) + j ( V {1}_{PCC - Imag} + V {2}_{PCC - Imag} + V {0}_{PCC - Imag} ) \qquad Eq . ( 6 )$$

$${V}_{BG} = {V}_{BG - Real} + {V}_{BG - Imag} = ( V {1}_{PCC - Real} - 0.5 V {2}_{PCC - Real} + 0.866 V {2}_{PCC - Imag} - 0.5 V {0}_{PCC - Real} - 0.866 V {0}_{PCC - Imag} ) + j ( V {1}_{PCC - Imag} - 0.5 V {2}_{PCC - Imag} - 0.866 V {2}_{PCC - Real} - 0.5 V {0}_{PCC - Imag} + 0.866 V {0}_{PCC - Imag} ) \qquad Eq . ( 7 )$$

$${V}_{CG} = {V}_{CG - Real} + {V}_{CG - Imag} = ( V {1}_{PCC - Real} - 0.5 V {2}_{PCC - Real} - 0.866 V {2}_{PCC - Imag} - 0.5 V {0}_{PCC - Real} + 0.866 V {0}_{PCC - Imag} ) + j ( V {1}_{PCC - Imag} - 0.5 V {2}_{PCC - Imag} + 0.866 V {2}_{PCC - Real} - 0.5 V {0}_{PCC - Imag} - 0.866 V {0}_{PCC - Imag} ) \qquad Eq . ( 8 )$$

The maximum TOV at the PCC 16 is equal to the maximum of these three-phase voltages. As such,

$${V}_{PH - MAX} = max ( \vert {V}_{AG} \vert , \vert {V}_{BG} \vert , \vert {V}_{CG} \vert ) \qquad Eq . ( 9 )$$

The Coefficient of Grounding (COG) is equal to the maximum phase to ground voltage normalized using the system line-to-line voltage. Therefore,

$$COG = {V}_{PH - MAX} / 1.732 \qquad Eq . ( 10 )$$

This coefficient shows how the system grounding is effective. A sensitivity analysis is then performed to examine the impacts of various parameters on the COG, as described in the following subsection.

### Sensitivity Analysis

The tool runs numerous calculations considering multiple (e.g., all) possible values of two or more of the following variables:
1. BESS negative-sequence impedance, i.e., Z2_{BESS}
2. X/R ratio of the BESS negative-sequence impedance, i.e., XR_{BESS}
3. BESS transformer NGR resistance, i.e., R_{NGR-BESS-TX}
4. PV negative-sequence impedance, i.e., Z2_{PV}
5. X/R ratio of the PV negative-sequence impedance, i.e., XR_{PV}
6. Grounding transformer impedance (p.u.), i.e., Z_{GT}
7. X/R ratio of the grounding transformer Impedance (p.u.), i.e., XR_{GT}

Table 1 illustrates one approach to sweep over multiple (e.g., all) values for each of these variables. SLIDER1 sweeps over multiple values of the BESS negative-sequence impedance, i.e., Z2_{BESS}. Multiple values (0.1, 1, 10, and 20) are predefined for X/R ratio of the BESS negative-sequence impedance, i.e., XR_{BESS}. SLIDER2 sweeps over multiple values for the BESS transformer NGR resistance, i.e., R_{NGR-BESS-TX}. SLIDER3 sweeps over multiple values for the PV negative-sequence impedance, i.e., Z2pv. Multiple values (01., 1, 10, and 20) are predefined for X/R ratio of the PV negative-sequence impedance, i.e., XR_{PV}. SLIDER4 sweeps over multiple values for the grounding transformer impedance (p.u.), i.e., Z_{GT}. And multiple values (4, 6, and 10) are predefined for the X/R ratio of the grounding transformer Impedance (p.u.), i.e., XR_{GT}. Table 1 also shows that a SLIDER5 may be defined to adapt R_{NGR-GT} over one or more variables if desired. Any of these variables may exemplify the unknown parameter(s) discussed herein.

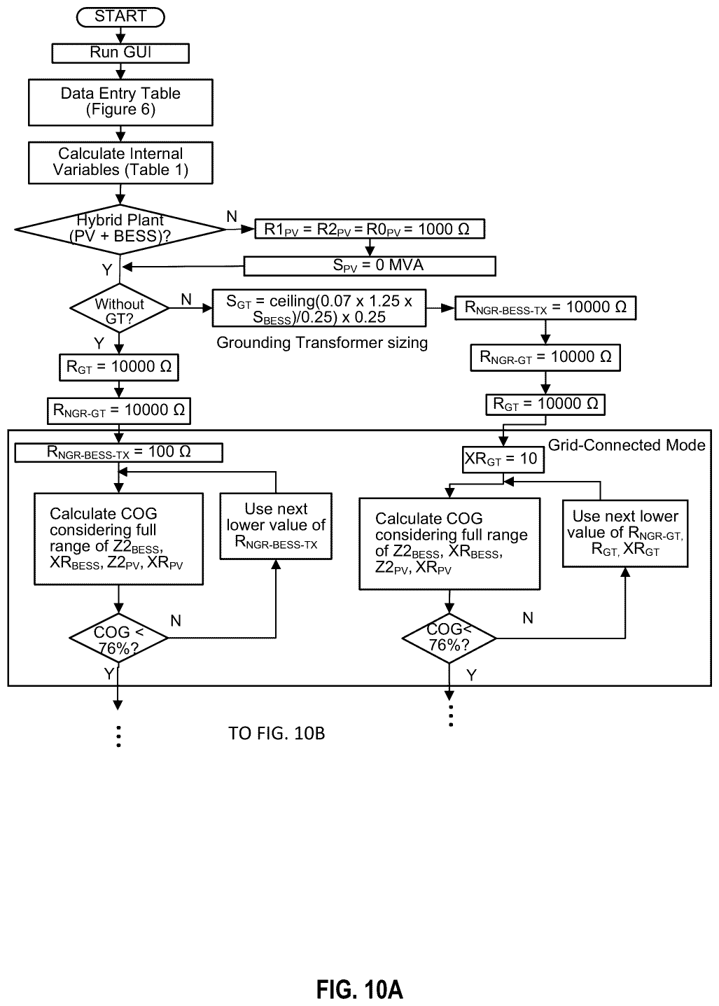

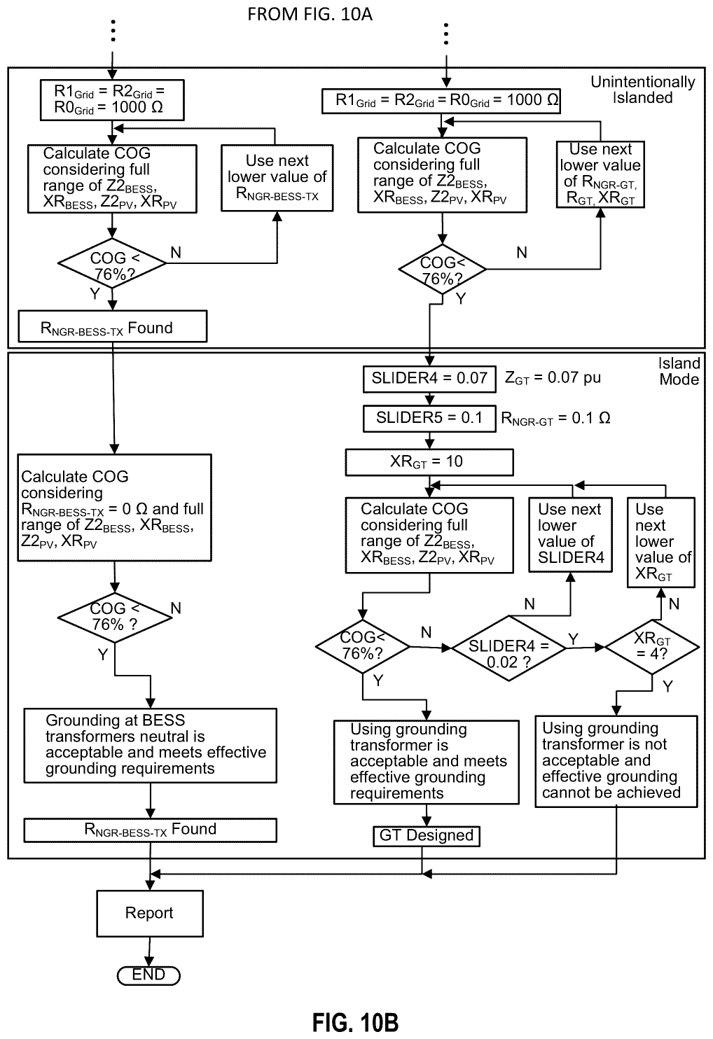

In some embodiments, the equations listed in the previous section are solved for the entire range of these seven variables to calculate the maximum TOV and COG under various conditions. The flowchart in FIGS. 10A-10B illustrates one approach to this via an iterative process. Here, for the type of grounding equipment that does not use a dedicated grounding transformer, the neutral grounding resistance R_{NGR-BESS-TX} is iteratively decremented (as an example of the sizing configuration herein), until the COG falls below the COG threshold of 76% across the modes of operation (grid-connected, islanded, and unintentionally islanded). Similarly, for the type of grounding equipment that is a dedicated grounding transformer, the neutral grounding resistance R_{NGR-GT} is iteratively decremented, along with R_{GT}, XR_{GT} (as an example of the sizing configuration herein), until the COG falls below the COG threshold of 76% across the modes of operation (grid-connected, islanded, and unintentionally islanded). For each grounding equipment type, the grounding method and impedance that results in a COG of less than 76% (considering 4% for securing the effective grounding design requirement of COG <80%) may be considered as the outcome, i.e., the determined design 50.

After calculating the grounding equipment sizing, some embodiments check whether the sizing meets requirements across multiple operating modes and/or across different values of unknown parameters. In one embodiment, if the sizing doesn't meet the requirements, a user may manually trigger a loop to retry with different parameter values. In another embodiment, if the sizing doesn't meet the requirements, the tool automatically triggers a loop to retry with different parameter values, in an attempt to determine the smallest sizing that satisfies the requirements.

Generally, then, some embodiments herein exploit an analytical approach for determining the best grounding approach (i.e., type) and sizing of the grounding impedance that meets standards/industry requirements. Some embodiments thereby offer a systematical approach for performing TOV analysis considering different system operating conditions as well as various system parameters to identify the suitable grounding design for DER interconnection and/or microgrid operation. Some embodiments accordingly help power engineers to determine the proper level of TOVs in their interconnection projects and achieve effective neutral grounding requirements without de-sensitizing the utility overcurrent protective relays while saving noticeable execution time and budget. Some embodiments may also enable a designer to fine-tune the grounding design based on the available equipment as well as system requirements while limiting the TOV level and ground fault current reduction.

Some embodiments advantageously provide an approach for sizing neutral grounding equipment such as grounding transformer and/or neutral grounding impedance for inverter-based DER interconnection projects. Some embodiments are applicable even for the special characteristics of the inverter-based DER. Even in this context, some embodiments provide analysis and sensitivity investigation via a systematic analytical approach.

Some embodiments herein also notably provide TOV and COG calculations considering the entire range of inverters negative-sequence impedance.

Some embodiments herein significantly reduce the studies execution duration and effort, while offering significant accuracy gain.

Some embodiments herein provide an engineering report with required sizing parameters that can be used for ordering (procurement) and implementation of the grounding equipment design.

Some embodiments herein provide sizing and/or selection of grounding equipment appropriate across multiple modes of operation, e.g., grid-connected and islanded. Alternatively or additionally, some embodiments herein provide sizing and/or selection of grounding equipment to account for uncertainty in the value of each of one or more parameters, e.g., for inverter-based resources.

Certain embodiments may provide one or more of the following technical advantage(s). Some embodiments provide coverage of any type of DER including Inverter-based DER with uncharacterized fault current behavior. Alternatively or additionally, some embodiments provide selection of the right neutral grounding method, i.e., using a grounding transformer or utilizing generator step-up transformers ground paths. Alternatively or additionally, some embodiments provide sizing of neutral grounding equipment such as grounding transformer and/or neutral grounding resistance based on IEEE Std. C57.32, IEEE Std. C62.92.1, IEEE Std. C62.92.2, IEEE Std. C62.92.6, and IEEE Std. 142. Alternatively or additionally, some embodiments avoid over-dimensioning grounding, thereby reducing costs while ensuring confidence in protection. Alternatively or additionally, some embodiments perform TOV and COG value calculation from the analysis in three important conditions of an inverter-based DER interconnection project including grid-connected mode, unplanned islanding, and (planned) island mode. Some embodiments are advantageously suitable for all types of inverter-based DERs such as PV and/or ESS applications, which are the most challenging cases. Some embodiments perform sensitivity analysis (running several thousand case studies in a short timeframe) to help the user identify the best grounding option. Alternatively or additionally, some embodiments provide validation using power-flow analysis.

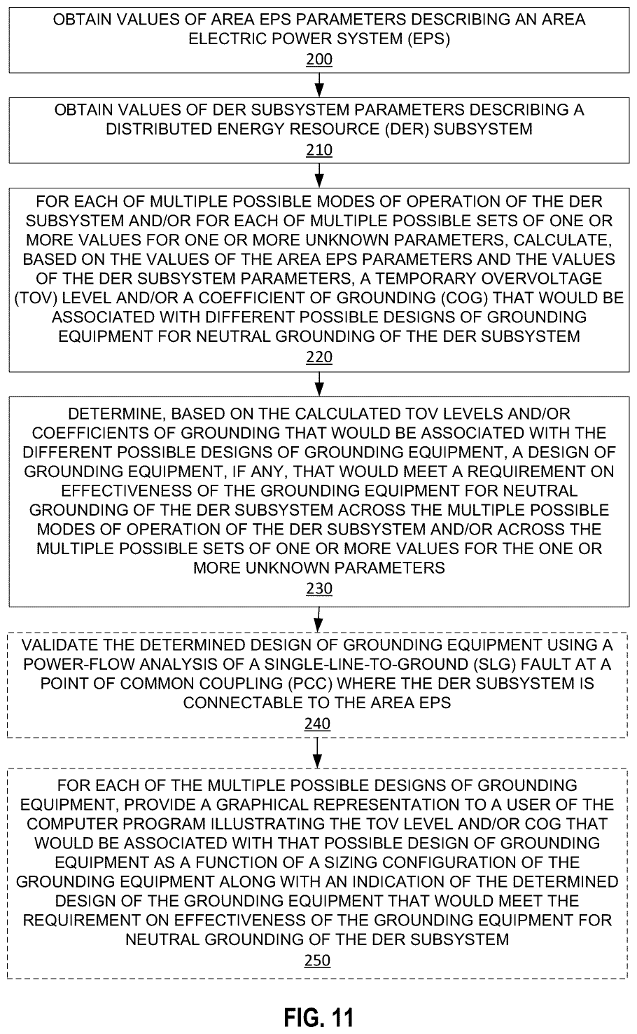

In view of the modifications and variations herein, FIG. 11 depicts a method of designing grounding equipment 40 to account for interconnection of a DER subsystem 10 to an area EPS 30 in accordance with particular embodiments. The method includes obtaining values 30P of area EPS parameters describing an area electric power system (EPS) 30 (Block 200). The method also includes obtaining values 10P of DER subsystem parameters describing a distributed energy resource (DER) subsystem 10 (Block 210). The method also includes, for each of multiple possible modes 20 of operation of the DER subsystem 10 and/or for each of multiple possible sets 22 of one or more values for one or more unknown parameters, calculating, based on the values 30P of the area EPS parameters and the values 10P of the DER subsystem parameters, a temporary overvoltage (TOV) level and/or a coefficient of grounding (COG) 64 that would be associated with different possible designs 50 of grounding equipment 40 for neutral grounding of the DER subsystem 10 (Block 220).

In some embodiments, the different possible designs 50 of grounding equipment 40 comprise different possible types 52 of grounding equipment 40 and/or different possible sizing configurations 54 of grounding equipment 40. In some embodiments, the multiple possible modes 20 include an area EPS connected mode in which the DER subsystem 10 is connected to the area EPS 30 and an island mode in which the DER subsystem 10 is islanded from the area EPS 30, and each of the one or more unknown parameters is associated with a negative-sequence impedance of the DER subsystem 10.

The method also includes determining, based on the calculated TOV levels and/or a COG 64 that would be associated with the different possible designs 50 of grounding equipment 40, a design 50 of grounding equipment 40, if any, that would meet a requirement 68 on effectiveness of the grounding equipment 40 for neutral grounding of the DER subsystem 10 across the multiple possible modes 20 of operation of the DER subsystem 10 and/or across the multiple possible sets 22 of one or more values for the one or more unknown parameters (Block 230).

In some embodiments, the method comprises, for each of the multiple possible modes 20 of operation of the DER subsystem 10 and/or for each of the multiple possible sets 22 of one or more values for the one or more unknown parameters, calculating the TOV level and/or the COG 64 that would be associated with the different possible designs 50 of the grounding equipment 40 during a single-line-to-ground (SLG) fault at a Point of Common Coupling (PCC) where the DER subsystem 10 is connectable to the area EPS 30.

In some embodiments, the method comprises, for each of the multiple possible modes 20 of operation of the DER subsystem 10 and/or for each of the multiple possible sets 22 of one or more values for the one or more unknown parameters, calculating the TOV level and/or the COG 64 that would be associated with the different possible designs 50 of the grounding equipment 40, for each possible design 50 of the grounding equipment 40.

In some embodiments, calculating the TOV level and/or the COG 64 includes, for each possible design 50 of the grounding equipment 40, calculating currents in a sequence components network for the possible mode of operation of the DER subsystem 10 as neutrally grounded during the SLG fault by the grounding equipment 40 designed according to the possible design 50, wherein the currents are calculated as a function of the values 30P of the area EPS parameters, the values 10P of the DER subsystem parameters, the one mor more possible values of the one or more unknown parameters, and values of parameters defining the possible design 50 of the grounding equipment 40.

In some embodiments, calculating the TOV level and/or the COG 64 includes, for each possible design 50 of the grounding equipment 40, calculating, as a function of the currents and load sequence impedances in the sequence components network, sequence voltages at the PCC.

In some embodiments, calculating the TOV level and/or the COG 64 includes, for each possible design 50 of the grounding equipment 40, calculating three-phase voltages at the PCC as a function of the sequence voltages at the PCC.

In some embodiments, calculating the TOV level and/or the COG 64 includes, for each possible design 50 of the grounding equipment 40, calculating the TOV level as a maximum of the three-phase voltages and/or calculating the COG 64 as the TOV level normalized to a line-to-line voltage at the PCC.

In some embodiments, the different possible designs 50 of grounding equipment 40 include, for each of one or more possible types 52 of grounding equipment 40, different possible sizing configurations 54 of grounding equipment 40 of that type. In some embodiments, the different possible sizing configurations 54 have at least some different values for one or more sizing parameters of grounding equipment 40 of the type. In one or more such embodiments, the method may comprise determining, for each of the one or more possible types 52 of grounding equipment 40, a smallest sizing configuration of grounding equipment 40 of the type that would meet the requirement 68 on effectiveness of the grounding equipment 40 for neutral grounding of the DER subsystem 10 across the multiple possible modes 20 of operation of the DER subsystem 10 and across the multiple possible sets 22 of one or more values for the one or more unknown parameters.

In some embodiments, the one or more sizing parameters include a neutral grounding resistance parameter defining a neutral grounding resistance of the grounding equipment 40. In some embodiments, the one or more sizing parameters include at least a neutral grounding reactance parameter defining a neutral grounding reactance of the grounding equipment 40. In other embodiments, the one or more sizing parameters include at least an impedance parameter defining an impedance of the grounding equipment 40. In yet other embodiments, the one or more sizing parameters include at least a resistance parameter defining a resistance of the grounding equipment 40. In still yet other embodiments, the one or more sizing parameters include at least a reactance-to-resistance parameter defining a ratio of a reactance of the grounding equipment 40 to a resistance of the grounding equipment 40. In some embodiments, the one or more sizing parameters include a power rating parameter defining a power rating of the grounding equipment 40.

In some embodiments, the one or more possible types 52 of grounding equipment 40 include multiple possible types 52 of grounding equipment 40, including a dedicated grounding transformer or a dedicated bank of multiple grounding transformers, and a DER subsystem transformer that connects the DER subsystem 10 to the area EPS 30 and that is also used for neutral grounding of the DER subsystem 10.

In some embodiments, the requirement 68 is that a COG 64 associated with the grounding equipment 40 be below a COG threshold.

In some embodiments, the different possible modes 20 of operation of the DER subsystem 10 are successively ordered in an evaluation order. In one such embodiment, the method comprises determining, for each of the one or more possible types 52 of grounding equipment 40, the smallest sizing configuration of grounding equipment 40 of the type that would result in a COG 64 associated with the grounding equipment 40 being below the COG threshold across the multiple possible modes 20 of operation of the DER subsystem 10 and across the multiple possible sets 22 of one or more values for the one or more unknown parameters.

In some embodiments, the smallest sizing configuration of grounding equipment 40 is determined by: initializing the one or more sizing parameters for the grounding equipment 40 of the type to one or more initial values calculated based on the values of the area EPS parameters and the values 10P of the DER subsystem parameters; for the first possible mode of operation of the DER subsystem 10 in the evaluation order, iteratively decrementing at least one of the one or more sizing parameters for the grounding equipment 40 of the type, as needed, down from the one or more initial values, until a COG 64 associated with the grounding equipment 40 falls below the COG threshold for each of the multiple possible sets 22 of one or more values for the one or more unknown parameters; and for each subsequent possible mode of operation of the DER subsystem 10 in the evaluation order, iteratively decrementing at least one of the one or more sizing parameters for the grounding equipment 40 of the type, as needed, down from one or more values of the one or more sizing parameters resulting from the previous possible mode of operation of the DER subsystem 10 in the evaluation order, until a COG 64 associated with the grounding equipment 40 falls below the COG threshold for each of the multiple possible sets 22 of one or more values for the one or more unknown parameters. In some embodiments, the smallest sizing configuration comprises the one or more sizing parameters with one or more values resulting from the last possible mode of operation of the DER subsystem 10 in the evaluation order.

In some embodiments, the multiple possible modes 20 of operation of the DER subsystem 10 include the area EPS connected mode, the island mode, and an unintentionally islanded mode. In some embodiments, the unintentionally islanded mode is a mode in which the DER subsystem 10 is transitioning from the area EPS connected mode to the islanded mode.

In some embodiments, the different possible designs 50 of grounding equipment 40 include different possible sizing configurations 54 of each of multiple possible types 52 of grounding equipment 40. In one such embodiment, the method comprises determining a smallest sizing configuration of grounding equipment 40 of each of the multiple possible types 52 that would meet the requirement 68 on effectiveness of the grounding equipment 40 for neutral grounding of the DER subsystem 10 across the multiple possible modes 20 of operation of the DER subsystem 10 and across the multiple possible sets 22 of one or more values for the one or more unknown parameters.

In some embodiments, the method comprises, for each of the multiple possible modes 20 of operation of the DER subsystem 10 and/or for each of the multiple possible sets 22 of one or more values for the one or more unknown parameters, calculating, based on the values 30P of the area EPS parameters and the values 10P of the DER subsystem parameters, the TOV level and/or the COG 64, as well as a ground fault current level, that would be associated with the different possible designs 50 of grounding equipment 40 configured for neutral grounding of the DER subsystem 10; and determining, based on the calculated TOV levels and/or coefficients of grounding, and based on the ground fault current level, the design 50 of grounding equipment 40, if any, that would meet the requirement 68 on effectiveness of the grounding equipment 40 for neutral grounding of the DER subsystem 10 across the multiple possible modes 20 of operation of the DER subsystem 10 and/or across the multiple possible sets 22 of one or more values for the one or more unknown parameters.

In some embodiments, the method further comprises validating the determined design 50 of grounding equipment 40 using a power-flow analysis of a single-line-to-ground (SLG) fault at a Point of Common Coupling (PCC) where the DER subsystem 10 is connectable to the area EPS 30 (Block 240).

In some embodiments, the method further comprises, for each of the multiple possible designs 50 of grounding equipment 40, providing a graphical representation to a user of the computer program illustrating the TOV level and/or COG 64 that would be associated with that possible design 50 of grounding equipment 40 as a function of a sizing configuration of the grounding equipment 40 along with an indication of the determined design 50 of the grounding equipment 40 that would meet the requirement 68 on effectiveness of the grounding equipment 40 for neutral grounding of the DER subsystem 10 (Block 250).

In some embodiments, the method comprises displaying a user interface to a user of the computer program and to obtain the values 30P of the area EPS parameters and the values 10P of the DER subsystem parameters by receiving the values 30P of the area EPS parameters and the values 10P of the DER subsystem parameters as input by the user via the user interface.

In some embodiments, the DER subsystem 10 includes one or more types of inverter-based resources.

In some embodiments, the one or more unknown parameters include at least a parameter defining an energy storage system (ESS) negative-sequence impedance of the DER subsystem 10. In other embodiments, the one or more unknown parameters include at least a parameter defining a ratio of a reactance to resistance of the ESS negative-sequence impedance of the DER subsystem 10. In yet other embodiments, the one or more unknown parameters include at least a parameter defining a photovoltaic (PV) negative-sequence impedance of the DER subsystem 10. In still yet other embodiments, the one or more unknown parameters include at least a parameter defining a ratio of a reactance to resistance of the PV negative-sequence impedance of the DER subsystem 10.

Although embodiments above have been described as selecting a grounding equipment design 50 from among multiple candidate designs, other embodiments herein may simply operate to confirm whether or not a single candidate or proposed design 50 meets an effective grounding requirement 68 across the multiple possible modes of operation of the DER subsystem and across the multiple possible sets of one or more values for the one or more unknown parameters.

Embodiments herein also include corresponding apparatuses. Embodiments herein for instance include computing equipment 60 configured to perform any of the steps of any of the embodiments described above.

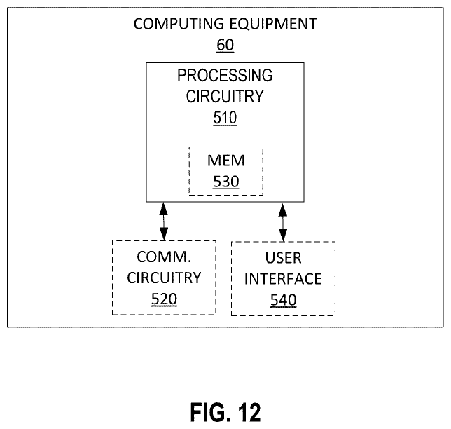

FIG. 12 shows computing equipment 60 according to one or more embodiments in this regard. As shown, the computing equipment 60 comprises processing circuitry 510. The processing circuitry 510 is configured to perform any of the steps of any of the embodiments described above. In some embodiments, for example, the computing equipment 60 includes memory 530 which contains instructions executable by the processing circuitry 510 whereby the computing equipment 60 is configured to perform any of the steps of any of the embodiments described above.

In some embodiments, the computing equipment 60 further comprises a user interface 540, e.g., for interfacing with a user of the computing equipment 60 in any of the ways described herein. Alternatively or additionally, the computing equipment 60 may have communication circuitry 520, e.g., configured for obtaining values of parameters herein and/or for interacting with a remote user in any of the ways described herein, with the remote user interacting with a user interface of remote computing equipment.

More particularly, the computing equipment 60 described above may perform the methods herein and any other processing by implementing any functional means, modules, units, or circuitry. In one embodiment, for example, the computing equipment 60 comprises respective circuits or circuitry configured to perform the steps shown in the method figures. The circuits or circuitry in this regard may comprise circuits dedicated to performing certain functional processing and/or one or more microprocessors in conjunction with memory. For instance, the circuitry may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory may include program instructions for carrying out one or more of the techniques described herein, in several embodiments. In embodiments that employ memory, the memory stores program code that, when executed by the one or more processors, carries out the techniques described herein.

Those skilled in the art will also appreciate that embodiments herein further include corresponding computer programs.

A computer program comprises instructions which, when executed on at least one processor of computing equipment 60, cause the computing equipment 60 to carry out any of the respective processing described above. A computer program in this regard may comprise one or more code modules corresponding to the means or units described above.

Embodiments further include a carrier containing such a computer program. This carrier may comprise one of an electronic signal, optical signal, radio signal, or computer readable storage medium.

In this regard, embodiments herein also include a computer program product stored on a non-transitory computer readable (storage or recording) medium and comprising instructions that, when executed by a processor of computing equipment 60, cause the computing equipment 60 to perform as described above.

Embodiments further include a computer program product comprising program code portions for performing the steps of any of the embodiments herein when the computer program product is executed by computing equipment 60. This computer program product may be stored on a computer readable recording medium.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole.

Embodiments herein also include a method for providing access to a cloud-based computer program over a network. The method may comprise providing a cloud-based computer program hosted on a remote server accessible via an internet website. The method further comprises receiving a subscription or access request from a user device connected to the Internet. The method further comprises granting access to the cloud-based computer program hosted on the remote server to the user device in response to the subscription or access request, wherein the cloud-based computer program comprises executable instructions for operating as described above, e.g., according to FIGS. 10A-10B

What is claimed is:

1. A non-transitory computer-readable medium on which is stored a computer program comprising instructions that, when executed by a processor of computing equipment, causes the computing equipment to:
obtain values of area EPS parameters describing an area electric power system (EPS);
obtain values of DER subsystem parameters describing a distributed energy resource (DER) subsystem;
for each of multiple possible modes of operation of the DER subsystem and/or for each of multiple possible sets of one or more values for one or more unknown parameters, calculate, based on the values of the area EPS parameters and the values of the DER subsystem parameters, a temporary overvoltage (TOV) level and/or a coefficient of grounding (COG) that would be associated with different possible designs of grounding equipment for neutral grounding of the DER subsystem, wherein the different possible designs of grounding equipment comprise different possible types of grounding equipment and/or different possible sizing configurations of grounding equipment, wherein the multiple possible modes include an area EPS connected mode in which the DER subsystem is connected to the area EPS and an island mode in which the DER subsystem is islanded from the area EPS, and wherein each of the one or more unknown parameters is associated with a negative-sequence impedance of the DER subsystem; and
determine, based on the calculated TOV levels and/or coefficients of grounding that would be associated with the different possible designs of grounding equipment, a design of grounding equipment, if any, that would meet a requirement on effectiveness of the grounding equipment for neutral grounding of the DER subsystem across the multiple possible modes of operation of the DER subsystem and/or across the different possible sets of one or more values for the one or more unknown parameters.

2. The non-transitory computer-readable medium of claim 1, wherein the instructions cause the computing equipment to, for each of the multiple possible modes of operation of the DER subsystem and/or for each of the multiple possible sets of one or more values for the one or more unknown parameters, calculate the TOV level and/or the COG that would be associated with the different possible designs of the grounding equipment during a single-line-to-ground (SLG) fault at a Point of Common Coupling (PCC) where the DER subsystem is connectable to the area EPS.

3. The non-transitory computer-readable medium of claim 2, wherein the instructions cause the computing equipment to, for each of the multiple possible modes of operation of the DER subsystem and/or for each of the multiple possible sets of one or more values for the one or more unknown parameters, calculate the TOV level and/or the COG that would be associated with the different possible designs of the grounding equipment, by, for each possible design of the grounding equipment:
calculating currents in a sequence components network for the possible mode of operation of the DER subsystem as neutrally grounded during the SLG fault by the grounding equipment designed according to the possible design, wherein the currents are calculated as a function of the values of the area EPS parameters, the values of the DER subsystem parameters, one or more possible values of the one or more unknown parameters, and values of parameters defining the possible design of the grounding equipment;
calculating, as a function of the currents and load sequence impedances in the sequence components network, sequence voltages at the PCC;
calculating three-phase voltages at the PCC as a function of the sequence voltages at the PCC; and
calculating the TOV level as a maximum of the three-phase voltages and/or calculating the COG as the TOV level normalized to a line-to-line voltage at the PCC.

4. The non-transitory computer-readable medium of claim 1, wherein the different possible designs of grounding equipment include, for each of one or more possible types of grounding equipment, different possible sizing configurations of grounding equipment of that type, wherein the different possible sizing configurations have at least some different values for one or more sizing parameters of grounding equipment of the type, and wherein the instructions cause the computing equipment to determine, for each of the one or more possible types of grounding equipment, a smallest sizing configuration of grounding equipment of the type that would meet the requirement on effectiveness of the grounding equipment for neutral grounding of the DER subsystem across the multiple possible modes of operation of the DER subsystem and across the multiple possible sets of one or more values for the one or more unknown parameters.

5. The non-transitory computer-readable medium of claim 4, wherein the one or more sizing parameters include a neutral grounding resistance parameter defining a neutral grounding resistance of the grounding equipment.

6. The non-transitory computer-readable medium of claim 4, wherein the one or more sizing parameters include one or more of:
a neutral grounding reactance parameter defining a neutral grounding reactance of the grounding equipment;
an impedance parameter defining an impedance of the grounding equipment;
a resistance parameter defining a resistance of the grounding equipment; or
a reactance-to-resistance parameter defining a ratio of a reactance of the grounding equipment to a resistance of the grounding equipment.

7. The non-transitory computer-readable medium of claim 4, wherein the one or more sizing parameters include a power rating parameter defining a power rating of the grounding equipment.

8. The non-transitory computer-readable medium of claim 4, wherein the one or more possible types of grounding equipment include multiple possible types of grounding equipment, including:
a dedicated grounding transformer or a dedicated bank of multiple grounding transformers; and
a DER subsystem transformer that connects the DER subsystem to the area EPS and that is also used for neutral grounding of the DER subsystem.

9. The non-transitory computer-readable medium of claim 4, wherein the requirement is that a COG associated with the grounding equipment be below a COG threshold, wherein the different possible modes of operation of the DER subsystem are successively ordered in an evaluation order, and wherein the instructions cause the computing equipment to determine, for each of the one or more possible types of grounding equipment, the smallest sizing configuration of grounding equipment of the type that would result in a COG associated with the grounding equipment being below the COG threshold across the multiple possible modes of operation of the DER subsystem and across the multiple possible sets of one or more values for the one or more unknown parameters, by:
initializing the one or more sizing parameters for the grounding equipment of the type to one or more initial values calculated based on the values of the area EPS parameters and the values of the DER subsystem parameters;
for the first possible mode of operation of the DER subsystem in the evaluation order, iteratively decrementing at least one of the one or more sizing parameters for the grounding equipment of the type, as needed, down from the one or more initial values, until a COG associated with the grounding equipment falls below the COG threshold for each of the multiple possible sets of one or more values for the one or more unknown parameters; and
for each subsequent possible mode of operation of the DER subsystem in the evaluation order, iteratively decrementing at least one of the one or more sizing parameters for the grounding equipment of the type, as needed, down from one or more values of the one or more sizing parameters resulting from the previous possible mode of operation of the DER subsystem in the evaluation order, until a COG associated with the grounding equipment falls below the COG threshold for each of the multiple possible sets of one or more values for the one or more unknown parameters, wherein the smallest sizing configuration comprises the one or more sizing parameters with one or more values resulting from the last possible mode of operation of the DER subsystem in the evaluation order.

10. The non-transitory computer-readable medium of claim 1, wherein the multiple possible modes of operation of the DER subsystem include the area EPS connected mode, the island mode, and an unintentionally islanded mode, wherein the unintentionally islanded mode is a mode in which the DER subsystem is transitioning from the area EPS connected mode to the islanded mode.

11. The non-transitory computer-readable medium of claim 1, wherein the different possible designs of grounding equipment include different possible sizing configurations of each of multiple possible types of grounding equipment, and wherein the instructions cause the computing equipment to determine a smallest sizing configuration of grounding equipment of each of the multiple possible types that would meet the requirement on effectiveness of the grounding equipment for neutral grounding of the DER subsystem across the multiple possible modes of operation of the DER subsystem and across the multiple possible sets of one or more values for the one or more unknown parameters.

12. The non-transitory computer-readable medium of claim 1, wherein the instructions cause the computing equipment to:
for each of the multiple possible modes of operation of the DER subsystem and/or for each of the multiple possible sets of one or more values for the one or more unknown parameters, calculate, based on the values of the area EPS parameters and the values of the DER subsystem parameters, the TOV level and/or the COG, as well as a ground fault current level, that would be associated with the different possible designs of grounding equipment configured for neutral grounding of the DER subsystem; and
determine, based on the calculated TOV levels and/or coefficients of grounding, and based on the ground fault current level, the design of grounding equipment, if any, that would meet the requirement on effectiveness of the grounding equipment for neutral grounding of the DER subsystem across the multiple possible modes of operation of the DER subsystem and/or across the multiple possible sets of one or more values for the one or more unknown parameters.

13. The non-transitory computer-readable medium of claim 1, wherein the instructions further cause the computing equipment to validate the determined design of grounding equipment using a power-flow analysis of a single-line-to-ground (SLG) fault at a Point of Common Coupling (PCC) where the DER subsystem is connectable to the area EPS.

14. The non-transitory computer-readable medium of claim 1, wherein the instructions cause the computing equipment to, for each of the multiple possible designs of grounding equipment, provide a graphical representation to a user of the computer program illustrating the TOV level and/or COG that would be associated with that possible design of grounding equipment as a function of a sizing configuration of the grounding equipment along with an indication of the determined design of the grounding equipment that would meet the requirement on effectiveness of the grounding equipment for neutral grounding of the DER subsystem.

15. The non-transitory computer-readable medium of claim 1, wherein the instructions cause the computing equipment to display a user interface to a user of the computer program and to obtain the values of the area EPS parameters and the values of the DER subsystem parameters by receiving the values of the area EPS parameters and the values of the DER subsystem parameters as input by the user via the user interface.

16. The non-transitory computer-readable medium of claim 1, wherein the DER subsystem includes one or more types of inverter-based resources.

17. The non-transitory computer-readable medium of claim 1, wherein the one or more unknown parameters include one or more of:
a parameter defining an energy storage system (ESS) negative-sequence impedance of the DER subsystem;
a parameter defining a ratio of a reactance to resistance of the ESS negative-sequence impedance of the DER subsystem;
a parameter defining a photovoltaic (PV) negative-sequence impedance of the DER subsystem; or
a parameter defining a ratio of a reactance to resistance of the PV negative-sequence impedance of the DER subsystem.

18. A method of designing grounding equipment to account for interconnection of a distributed energy resource (DER) subsystem to an area electric power system (EPS), the method comprising:
obtaining values of area EPS parameters describing an area electric power system (EPS);
obtaining values of DER subsystem parameters describing a distributed energy resource (DER) subsystem;
for each of multiple possible modes of operation of the DER subsystem and/or for each of multiple possible sets of one or more values for one or more unknown parameters, calculating, based on the values of the area EPS parameters and the values of the DER subsystem parameters, a temporary overvoltage (TOV) level and/or a coefficient of grounding (COG) that would be associated with different possible designs of grounding equipment for neutral grounding of the DER subsystem, wherein the different possible designs of grounding equipment comprise different possible types of grounding equipment and/or different possible sizing configurations of grounding equipment, wherein the multiple possible modes include an area EPS connected mode in which the DER subsystem is connected to the area EPS and an island mode in which the DER subsystem is islanded from the area EPS, and wherein each of the one or more unknown parameters is associated with a negative-sequence impedance of the DER subsystem; and
determining, based on the calculated TOV levels and/or coefficients of grounding that would be associated with the different possible designs of grounding equipment, a design of grounding equipment, if any, that would meet a requirement on effectiveness of the grounding equipment for neutral grounding of the DER subsystem across the multiple possible modes of operation of the DER subsystem and/or across the multiple possible sets of one or more values for the one or more unknown parameters.

19. The method of claim 18, wherein said calculating comprises, for each of the multiple possible modes of operation of the DER subsystem and/or for each of the multiple possible sets of one or more values for the one or more unknown parameters, calculating the TOV level and/or the COG that would be associated with the different possible designs of the grounding equipment during a single-line-to-ground (SLG) fault at a Point of Common Coupling (PCC) where the DER subsystem is connectable to the area EPS.

20. The method of claim 19, wherein said calculating comprises, for each of the multiple possible modes of operation of the DER subsystem and/or for each of the multiple possible sets of one or more values for the one or more unknown parameters, calculating the TOV level and/or the COG that would be associated with the different possible designs of the grounding equipment, by, for each possible design of the grounding equipment:
calculating currents in a sequence components network for the possible mode of operation of the DER subsystem as neutrally grounded during the SLG fault by the grounding equipment designed according to the possible design, wherein the currents are calculated as a function of the values of the area EPS parameters, the values of the DER subsystem parameters, one or more possible values of the one or more unknown parameters, and values of parameters defining the possible design of the grounding equipment;
calculating, as a function of the currents and load sequence impedances in the sequence components network, sequence voltages at the PCC;
calculating three-phase voltages at the PCC as a function of the sequence voltages at the PCC; and
calculating the TOV level as a maximum of the three-phase voltages and/or calculating the COG as the TOV level normalized to a line-to-line voltage at the PCC.

21. The method of claim 18, wherein the different possible designs of grounding equipment include, for each of one or more possible types of grounding equipment, different possible sizing configurations of grounding equipment of that type, wherein the different possible sizing configurations have at least some different values for one or more sizing parameters of grounding equipment of the type, and wherein said determining comprises determining, for each of the one or more possible types of grounding equipment, a smallest sizing configuration of grounding equipment of the type that would meet the requirement on effectiveness of the grounding equipment for neutral grounding of the DER subsystem across the multiple possible modes of operation of the DER subsystem and across the multiple possible sets of one or more values for the one or more unknown parameters.

22. The method of claim 21, wherein the one or more sizing parameters include:
a neutral grounding resistance parameter defining a neutral grounding resistance of the grounding equipment; and/or
a power rating parameter defining a power rating of the grounding equipment.

23. The method of claim 21, wherein the one or more possible types of grounding equipment include multiple possible types of grounding equipment, including:
a dedicated grounding transformer or a dedicated bank of multiple grounding transformers; and
a DER subsystem transformer that connects the DER subsystem to the area EPS and that is also used for neutral grounding of the DER subsystem.

24. The method of claim 21, wherein the requirement is that a COG associated with the grounding equipment be below a COG threshold, wherein the different possible modes of operation of the DER subsystem are successively ordered in an evaluation order, and wherein said determining comprises determining, for each of the one or more possible types of grounding equipment, the smallest sizing configuration of grounding equipment of the type that would result in a COG associated with the grounding equipment being below the COG threshold across the multiple possible modes of operation of the DER subsystem and across the multiple possible sets of one or more values for the one or more unknown parameters, by:
initializing the one or more sizing parameters for the grounding equipment of the type to one or more initial values calculated based on the values of the area EPS parameters and the values of the DER subsystem parameters;
for the first possible mode of operation of the DER subsystem in the evaluation order, iteratively decrementing at least one of the one or more sizing parameters for the grounding equipment of the type, as needed, down from the one or more initial values, until a COG associated with the grounding equipment falls below the COG threshold for each of the multiple possible sets of one or more values for the one or more unknown parameters; and
for each subsequent possible mode of operation of the DER subsystem in the evaluation order, iteratively decrementing at least one of the one or more sizing parameters for the grounding equipment of the type, as needed, down from one or more values of the one or more sizing parameters resulting from the previous possible mode of operation of the DER subsystem in the evaluation order, until a COG associated with the grounding equipment falls below the COG threshold for each of the multiple possible sets of one or more values for the one or more unknown parameters, wherein the smallest sizing configuration comprises the one or more sizing parameters with one or more values resulting from the last possible mode of operation of the DER subsystem in the evaluation order.

25. The method of claim 18, wherein the different possible designs of grounding equipment include different possible sizing configurations of each of multiple possible types of grounding equipment, and wherein said determining comprises determining a smallest sizing configuration of grounding equipment of each of the multiple possible types that would meet the requirement on effectiveness of the grounding equipment for neutral grounding of the DER subsystem across the multiple possible modes of operation of the DER subsystem and across the multiple possible sets of one or more values for the one or more unknown parameters.

26. The method of claim 18, further comprising validating the determined design of grounding equipment using a power-flow analysis of a single-line-to-ground (SLG) fault at a Point of Common Coupling (PCC) where the DER subsystem is connectable to the area EPS.

27. The method of claim 18, further comprising, for each of the multiple possible designs of grounding equipment, providing a graphical representation illustrating the TOV level and/or COG that would be associated with that possible design of grounding equipment as a function of a sizing configuration of the grounding equipment along with an indication of the determined design of the grounding equipment that would meet the requirement on effectiveness of the grounding equipment for neutral grounding of the DER subsystem.

28. The method of claim 18, wherein the DER subsystem includes one or more types of inverter-based resources.

29. A method for distributing a computer program over a network, comprising:
providing a downloadable computer program accessible via an Internet website;
receiving a request for the downloadable computer program from a user device connected to the Internet; and
transmitting the downloadable computer program from a server to the user device in response to the request, wherein the downloadable computer program comprises executable instructions for:
obtaining values of area EPS parameters describing an area electric power system (EPS);
obtaining values of DER subsystem parameters describing a distributed energy resource (DER) subsystem;
for each of multiple possible modes of operation of the DER subsystem and/or for each of multiple possible sets of one or more values for one or more unknown parameters, calculating, based on the values of the area EPS parameters and the values of the DER subsystem parameters, a temporary overvoltage (TOV) level and/or a coefficient of grounding (COG) that would be associated with different possible designs of grounding equipment for neutral grounding of the DER subsystem, wherein the different possible designs of grounding equipment comprise different possible types of grounding equipment and/or different possible sizing configurations of grounding equipment, wherein the multiple possible modes include an area EPS connected mode in which the DER subsystem is connected to the area EPS and an island mode in which the DER subsystem is islanded from the area EPS, and wherein each of the one or more unknown parameters is associated with a negative-sequence impedance of the DER subsystem; and
determining, based on the calculated TOV levels and/or coefficients of grounding that would be associated with the different possible designs of grounding equipment, a design of grounding equipment, if any, that would meet a requirement on effectiveness of the grounding equipment for neutral grounding of the DER subsystem across the multiple possible modes of operation of the DER subsystem and/or across the multiple possible sets of one or more values for the one or more unknown parameters.
